(19) United States
(12) Patent Application Publication
(10) Pub. No.: US 2013/0189944 A1
(43) Pub. Date: Jul. 25, 2013

(54) TRACKING AND REPORTING INFORMATION CHARACTERIZING ATTACKS CAUSED BY A DISEASE

(71) Applicant: Kate McCoy, Watertown, MA (US)

(72) Inventor: Kate McCoy, Watertown, MA (US)

(73) Assignee: Dyax Corp., Burlington, MA (US)

(21) Appl. No.: 13/742,946

(22) Filed: Jan. 16, 2013

Related U.S. Application Data
(60) Provisional application No. 61/589,134, filed on Jan. 20, 2012.

(51) Int. Cl. H04W 4/22; G08B 21/02

(52) U.S. Cl. CPC H04W 4/22; G08B 21/02
USPC 455/404.1; 340/539.12; 715/764

(57) ABSTRACT

Methods and apparatus for tracking and monitoring information related to an attack caused by a disease. A portable electronic device such as a smartphone or portable computer is used to collect personal information about one or more attack episodes. The personal information is associated with temporal information for the attack and the personal information and temporal information is stored in at least one storage device associated with the portable electronic device. The stored personal and temporal information may be used to generate one or more reports displaying trends for one or more report metrics. Emergency information related to the disease and stored on the portable electronic device may be output from the portable electronic device in an emergency situation.

### RELATED APPLICATIONS

This application claims priority under 35 U.S.C. §119(e) to U.S. Provisional Application Ser. No. 61/589,134, entitled “TRACKING AND REPORTING INFORMATION CHARACTERIZING ATTACKS CAUSED BY A DISEASE” filed on Jan. 20, 2012, which is herein incorporated by reference in its entirety.

### BACKGROUND

Some diseases, such as hereditary angioedema (HAE), are characterized by periodic attack episodes in which the patient may experience uncomfortable or painful symptoms. HAE is a rare genetic disease of the immune system that causes attacks of spontaneous cutaneous or subcutaneous swelling. Attacks caused by HAE are often unpredictable and can happen anywhere on the body, but typically affect the face, hands, feet, genitals, abdomen, and/or larynx. Some patients with HAE may identify one or more triggers for their attacks such as trauma and stress, although many attacks may occur without an identifiable trigger. Additionally, some attacks may be preceded by a “prodrome,” in which the patient experiences warning signs of the impending attack including a rash, or an unnatural sensation in the skin. Although the symptoms of some attacks may resolve over time on their own or with medication, other attacks, particularly those affecting breathing due to swelling of the larynx, may require emergency medical attention to prevent serious bodily injury, including death.

Currently there is no cure for HAE, although some patients may take medication to help prevent and/or decrease the severity of attacks, and patients may be administered medications such as Kalbitor® (ecallantide) from Dyax Corporation, Burlington, Mass., to help alleviate the symptoms of an HAE attack and speed recovery. Other medications, including those to relieve pain symptoms, may also be used to manage symptoms of attacks.

A conventional approach for recording information related to attacks involved a patient either remembering or writing down symptoms in a diary when the patient experienced an attack. The recorded information was then reviewed with the patient's doctor during regular medical appointments and/or when the patient was hospitalized as a result of an attack. Patients diagnosed with diseases such as HAE may carry a card to identify themselves as having the disease should they experience an emergency attack and be unable to communicate with medical personnel or others regarding their condition.

### SUMMARY

Some embodiments are directed to improved methods and apparatus for tracking and monitoring information associated with attacks using a portable electronic device. By integrating a mobile application that enables a patient to accurately capture information related to their disease using portable electronic devices including, but not limited to, personal digital assistants (PDAs), smartphones, cell phones, tablet computers, and laptop computers, patients are able to track and monitor disease cause, symptoms, and treatments, analyze data to generate reports that may be shared with the patient's physician, and provide emergency information to others, if necessary, in an emergency situation.

Such a mobile application may aid a user in recording and/or analyzing personal information for attacks, which may in turn, allow the user to identify trends that may be helpful in preparing the user regarding future attacks. Personal information may relate to the user in any way and is not restricted to information that identifies the user, such as the user's name or date of birth. For example, personal information may include, but is not limited to, information that describes an attack, information that describes one or more triggers for an attack, and information that describes warning signs observed by a user prior to an attack.

Such a mobile application may also facilitate the communication of emergency information to others, if necessary, when a user determines that an attack is occurring and/or when an attack is likely to occur. Emergency information may relate to any relevant information that someone may need to know if, for example, a user is experiencing an attack and requires emergency services. For example, emergency information may include, but is not limited to, information identifying the user as having a particular disease, a message describing one or more aspects of the disease, emergency contact information, and information related to pharmaceutical allergies.

In some aspects, some embodiments of the invention may relate to a method of collecting information related to an attack caused by a disease, wherein the information is collected using a portable electronic device. The method comprises receiving from a user, via at least one user interface displayed by the portable electronic device, personal information characterizing at least one aspect of the attack; associating the received personal information with temporal information associated with the attack; and storing the personal information and the temporal information in at least one storage medium associated with the portable electronic device.

In some embodiments, the personal information includes information related to at least one physical warning sign observed by the user prior to the attack, and the information related to the at least one physical warning sign includes a photograph of the at least one physical warning sign.

In some embodiments, the personal information includes an identification of at least one physical symptom associated with the attack, the at least one physical symptom includes pain, and the personal information additionally includes a degree of pain associated with the attack.

In another aspect, some embodiments of the invention may relate to a computer-readable medium encoded with a plurality of instructions that, when executed by a computer, perform a method comprising displaying a user interface on a display of a portable electronic device, wherein the user interface includes at least one interactive field for collecting personal information from a user, wherein the personal information characterizes at least one aspect of an attack caused by a disease; receiving from a user, via the at least one interactive field, the personal information; and storing the personal information and temporal information associated with the attack in at least one storage medium associated with the portable electronic device.

In some embodiments, the user interface includes a plurality of navigation selectors, each configured to enable the user to navigate to a different page presented by the user interface.

In some embodiments, the plurality of navigation selectors include an attack navigation selector that, when selected by the user, result in the display of the at least one interactive field for collecting the personal information.

In some embodiments, the method further comprises receiving a request from the user to access previously-stored personal information associated with an attack, receiving modified personal information to associate with the attack, associating the modified personal information with the attack, and storing the modified personal information in the at least one storage medium associated with the portable electronic device.

In some embodiments, the modified personal information includes additional personal information not previously associated with the attack.

In some embodiments, the method further comprises prompting the user to select the temporal information associated with the attack and displaying on the user interface, in response to receiving a selection of temporal information from the user, a plurality of recording selectors that, when selected, result in the display of the at least one interactive field for collecting the personal information.

In some embodiments, the at least one interactive field includes a plurality of checkboxes identifying suspected triggers for the attack, and the method further comprises receiving a selection of at least one of the plurality of checkboxes for suspected triggers and storing one or more suspected triggers associated with the selection as personal information associated with the attack.

In some embodiments, the method further comprises displaying on the user interface, a plurality of suspected triggers for the attack, receiving an indication to add a new trigger not included in the displayed plurality of suspected triggers, prompting the user to input a name for the new trigger, and adding the new trigger to the plurality of suspected triggers for the attack in response to receiving the name for the new trigger.

In some embodiments, the method further comprises displaying, on the user interface, at least one symptom selector that, when selected, enables a user to input symptom information associated with the attack.

In some embodiments, the at least one symptom selector is selected from the group consisting of a swelling selector, a physical symptom selector, and a psychological symptom selector.

In some embodiments, the method further comprises receiving a selection of the swelling selector and displaying on the user interface, in response to receiving the selection, a plurality of checkboxes indicating body region locations of swelling.

In some embodiments, the method further comprises displaying on the user interface, a severity indicator configured to enable the user to indicate a severity of swelling associated with the attack.

In some embodiments, the method further comprises receiving a selection of the psychological symptom selector and displaying on the user interface, in response to receiving the selection, a plurality of checkboxes indicating emotional symptoms associated with the attack.

In some embodiments, the method further comprises displaying on the user interface, a treatment page configured to enable the user to input information related to treatment received for the attack.

In yet another aspect, some embodiments of the invention may relate to a method of generating a report including personal information related to one or more attacks caused by a disease. The method comprises receiving via a user interface displayed on a portable electronic device, a request from a user to generate the report; retrieving, from at least one storage device associated with the portable electronic device, personal information related to the one or more attacks; generating the report based, at least in part, on the retrieved personal information; and displaying the generated report on a display of the portable electronic device.

In some embodiments, the request to generate the report includes an indication to generate the report for a single attack, wherein generating the report comprises generating at least one graphical representation associated with the single attack, and wherein displaying the generated report comprises displaying the at least one graphical representation.

In some embodiments, the request to generate the report includes an indication to generate the report for a single attack, wherein generating the report comprises consolidating at least some of the retrieved personal information into an attack profile, wherein the attack profile includes information related to at least one physical symptom associated with the single attack, and wherein displaying the generated report comprises displaying a representation of the attack profile.

In some embodiments, the request to generate the report includes an indication to generate the report for a plurality of attacks over a predetermined time period, and the method further comprises aggregating the retrieved personal information for the plurality of attacks during the predetermined time period to produce aggregated personal information data and wherein displaying the generated report comprises displaying at least some of the aggregated personal information data

In some embodiments, the aggregated personal information data indicates a trend related to at least one of: a frequency of attacks, severity of attacks, frequency of identified triggers for attacks, and frequency of identified warning signs during the predetermined time period.

In some embodiments, the method further comprises receiving an input from the user identifying a desired predetermined time period to aggregate personal information for the report and wherein aggregating the retrieved personal information comprises aggregating the retrieved personal information for attacks associated with temporal data indicating that the attacks occurred during the desired predetermined time period.

In yet a further aspect, some embodiments of the invention may relate to a computer-readable medium encoded with a plurality of instructions that, when executed by a computer, perform a method of generating a report including personal information related to one or more attacks caused by a disease. The method comprises receiving via a user interface displayed on a portable electronic device, a request from a user to generate the report; retrieving from at least one storage device associated with the portable electronic device, personal information related to the one or more attacks; generating the report based, at least in part, on the retrieved personal information; and displaying the generated report on a display of the portable electronic device.

In some embodiments, the request to generate the report includes an indication to generate the report for a single attack, wherein generating the report comprises consolidating at least some of the retrieved personal information into an attack profile, wherein the attack profile includes information related to at least one physical symptom associated with the single attack, and wherein displaying the generated report comprises displaying a representation of the attack profile. The retrieved personal information includes at least one photograph associated with the attack, and displaying the generated report comprises displaying the at least one photograph.

In yet a further aspect, some embodiments of the invention may relate to a method of using a portable electronic device to communicate emergency information about an attack caused by a disease. The method comprises receiving an indication that an attack has occurred or is likely to occur; retrieving, with at least one processor, the emergency information from at least one storage medium associated with the portable electronic device; and outputting an indication of the emergency information in response to retrieving the emergency information from the at least one storage medium.

In some embodiments, the method further comprises displaying on the user interface, a message explaining at least one aspect of the disease.

In some embodiments, the method further comprises displaying a user interface on a display of the portable electronic device, wherein the user interface includes an emergency contact selector configured to enable a user to call emergency services.

In yet a further aspect, some embodiments of the invention may relate to a computer-readable medium encoded with a plurality of instructions that, when executed by a computer perform a method of communicating emergency information about an attack caused by a disease. The method comprises receiving an indication that an attack has occurred or is likely to occur; retrieving, with at least one processor, the emergency information from at least one storage medium associated with a portable electronic device; and outputting an indication of the emergency information in response to retrieving the emergency information from the at least one storage medium.

In some embodiments, the method further comprises displaying a user interface on a display of the portable electronic device, wherein the user interface is configured to prompt a user to input the emergency information, receiving the emergency information in response to a user interacting with the user interface, and storing the received emergency information in the at least one storage medium.

In some embodiments, the method further comprises displaying on the user interface a plurality of fields for inputting the emergency information.

In some embodiments, the method further comprises accessing personal information stored on the portable electronic device to complete at least some of the plurality of fields without input from the user.

In some embodiments, accessing personal information stored on the portable electronic device comprises accessing contact information stored on the portable electronic device.

In some embodiments, the method further comprises displaying on a display of the portable electronic device, a message explaining at least one aspect of the disease.

In some embodiments, outputting an indication of the emergency information comprises outputting from the portable electronic device, speech corresponding to the emergency information.

In some embodiments, the method further comprises displaying a user interface on a display of the portable electronic device, wherein the user interface includes an emergency contact selector configured to enable a user to call emergency services.

In some embodiments, the method further comprises receiving a selection of the emergency contact selector, prompting the user for confirmation to call emergency services, and initiating a call to emergency services in response to receiving confirmation from the user.

In some embodiments, the portable electronic device is selected from the group consisting of a cellular phone, a smartphone, a personal digital assistant, a tablet computer, and a laptop computer.

It should be appreciated that the above-described features and additional concepts discussed in greater detail below (provided such concepts are not mutually inconsistent) can be used alone or together in any suitable combination. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a portion of a user interface for tracking information associated with at least one attack in accordance with some embodiments of the invention;

FIG. 2 is a portion of a user interface displayed on a portable electronic device in accordance with some embodiments of the invention;

FIG. 3 is a general architecture for processing input in accordance with some embodiments of the invention;

FIG. 4 is a flow chart of a process for collecting information in accordance with some embodiments of the invention;

FIG. 5 is a portion of a user interface for selecting temporal information in accordance with some embodiments of the invention;

FIG. 6 is a portion of a user interface for selecting temporal information in accordance with some embodiments of the invention;

FIG. 7 is a portion of a user interface for selecting information to record in accordance with some embodiments of the invention;

FIG. 8 is a portion of a user interface for inputting attack episode information in accordance with some embodiments of the invention;

FIG. 9 is a portion of a user interface for inputting suspected trigger information for an attack in accordance with some embodiments of the invention;

FIG. 10 is a portion of a user interface for inputting suspected trigger information for an attack in accordance with some embodiments of the invention;

FIG. 11 is a portion of a user interface for inputting a name for a new suspected trigger for an attack in accordance with some embodiments of the invention;

FIG. 12 is a portion of a user interface for inputting pre-attack warning sign information for an attack in accordance with some embodiments of the invention;

FIG. 13 is a portion of a user interface for selecting a type of symptom information to record in accordance with some embodiments of the invention;

FIG. 14 is a portion of a user interface for inputting swelling symptom information in accordance with some embodiments of the invention;

FIG. 15 is a portion of a user interface for associating at least one photograph with symptom information in accordance with some embodiments of the invention;

FIG. 16 is a portion of a user interface for inputting physical symptom information in accordance with some embodiments of the invention;

FIG. 17 is a portion of a user interface for inputting psychological symptom information in accordance with some embodiments of the invention;

FIG. 18 is a portion of a user interface for inputting treatment information in accordance with some embodiments of the invention;

FIG. 19 is a flow chart of a process for generating a report in accordance with some embodiments of the invention;

FIG. 20 is a portion of a user interface for selecting a type of report in accordance with some embodiments of the invention;

FIG. 21 is a portion of a user interface for selecting temporal information to identify an attack episode in accordance with some embodiments of the invention;

FIG. 22 is a portion of a user interface for displaying an attack profile in accordance with some embodiments of the invention;

FIG. 23 is a portion of a user interface for sending an attack profile to another user in accordance with some embodiments of the invention;

FIG. 24 is a portion of a user interface for selecting a type of report including multiple attack episodes in accordance with some embodiments of the invention;

FIG. 25 is a portion of a user interface for displaying a frequency of attack graph in accordance with some embodiments of the invention;

FIG. 26 is a portion of a user interface for displaying a severity of attack graph in accordance with some embodiments of the invention;

FIG. 27 is a portion of a user interface for displaying a common trigger graph in accordance with some embodiments of the invention;

FIG. 28 is a portion of a user interface for displaying a common warning sign graph in accordance with some embodiments of the invention;

FIG. 29 is a portion of a user interface for displaying recorded notes associated with a common triggers in accordance with some embodiments of the invention;

FIG. 30 is a portion of a user interface for displaying recorded notes associated with a common warning signs in accordance with some embodiments of the invention;

FIG. 31 is a portion of a user interface for sending a report to another user in accordance with some embodiments of the invention;

FIG. 32 is a flow chart of a process for communicating emergency information in accordance with some embodiments of the invention;

FIG. 33 is a portion of a user interface for displaying emergency information in accordance with some embodiments of the invention;

FIG. 34 is a portion of a user interface for enabling a user to call emergency services in accordance with some embodiments of the invention;

FIG. 35 is a portion of a user interface for inputting emergency information in accordance with some embodiments of the invention;

FIG. 36 is a portion of a user interface for inputting emergency contact information in accordance with some embodiments of the invention; and

FIG. 37 is a schematic illustration of a computing system on which some embodiments of the invention may be employed.

### DETAILED DESCRIPTION

The inventor has recognized and appreciated that conventional methods for tracking personal information describing one or more aspects of an attack caused by a disease such as HAE may be improved by enabling a user to collect information about attacks using a portable electronic device such as a smartphone. Some embodiments of the invention may be implemented as a mobile application configured to execute on a mobile device platform such as iOS from Apple, Inc, Cupertino, Calif. or the open-platform, Android, or any other suitable mobile device platform employed on a portable electronic device.

As discussed above, conventional methods for collecting and reporting information about patient attacks often relied on patients having to remember or write down the details of what happened during the attacks, what caused the attacks, how the attacks were resolved, etc. so the patient could relate this information to his or her physician. However, due to the relative unpredictability of such attacks, the patient may not always have the necessary tools to write down what happened during the attack and the patient may forget the precise details of what happened by the time the information is recorded. Also, the patient may not consistently record all of the relevant information regarding an attack if recording such information is not performed in a standardized way.

For some diseases, such as HAE, the triggers and warning signs leading up to an attack may not be consistent across patients or even across time for any particular patient, so tracking information related to attacks in a consistent manner may be useful to enable the patient to be better prepared when an attack occurs. Additionally, this information may be shared with the patient's physician, which may result in more well-informed treatment recommendations for the patient to reduce the frequency and severity of attacks and/or to lessen the impact of attacks on the patient's life. Moreover, the severity and potential debilitating or life-threatening symptoms associated with diseases such as HAE underscores the importance of tracking and monitoring information related to HAE attacks to facilitate an effective treatment plan for patients living with HAE.

Determining trends related to various aspects of attacks is also useful in helping patients manage and be prepared for future attacks. Accordingly, some embodiments are directed to analyzing personal information that has been recorded for particular attacks to identify and generate reports detailing trends for one or more factors related to the attack, such as attack frequency, commonly reported triggers or warning sign, among others.

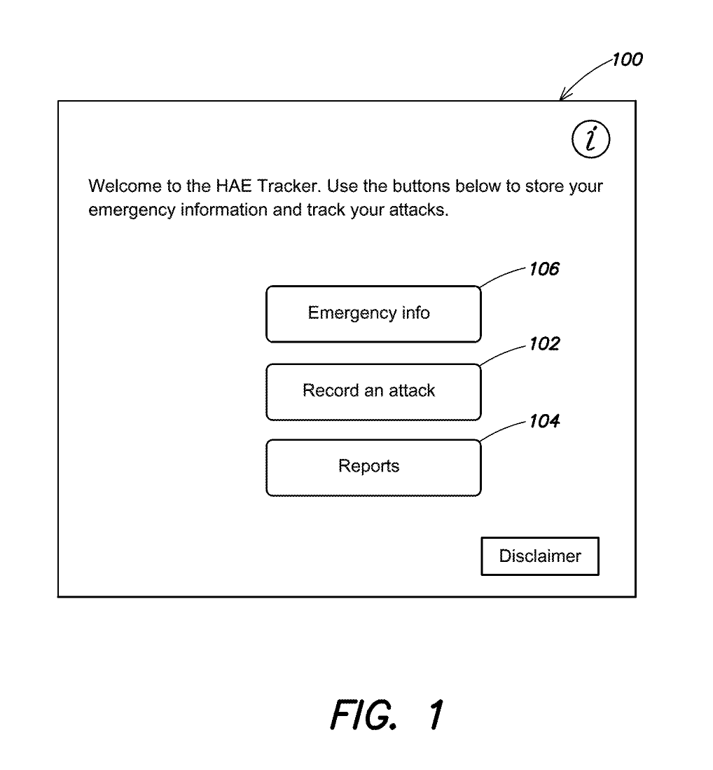

FIG. 1 illustrates an exemplary home page 100 portion of a user interface that may be displayed on a portable electronic device by execution of an application developed in accordance with some embodiments of the invention. Home page 100 includes a plurality of navigation selectors 102, 104, and 106 that, when selected by a user of the electronic device, result in navigation to different pages of the user interface on which the user may input and/or retrieve information associated with one or more attacks. Any suitable known or newly developed technology for inputting and outputting information on portable electronic devices may be used with embodiments of the invention. For example, mobile devices with touch-sensitive displays and/or speech recognition/speech synthesis capabilities are known and may be used for input and/or output in accordance with some embodiments.

Home page 100 includes attack navigation selector 102 that, when selected by a user, results in navigation to a page that enables a user to record information about an attack, as described in more detail below. Although each of the navigation selectors are illustrated in FIG. 1 as being selectable buttons labeled with text corresponding to their associated function, other implementations are also possible.

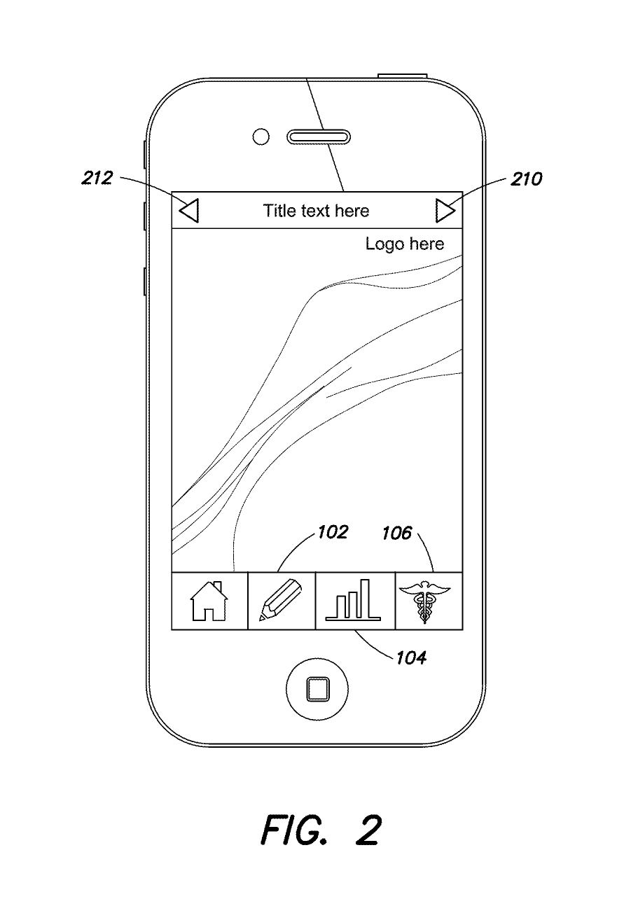

FIG. 2 illustrates an alternative user interface where each of the navigation selectors 102, 104, and 106 are represented by icons displayed on the user interface. Additionally, FIG. 2 illustrates other navigation selectors such as next selector 210 and previous selector 212, which enable a user to move forward or backward to steps in a predefined sequence of pages associated with the user interface. Accordingly, it should be appreciated that in some embodiments, a user may choose to navigate through pages of the user interface in an ordered manner using, for example, next selector 210 and previous selector 212 and/or the user may choose to browse pages of the user interface in a non-linear manner using navigation selectors 102, 104, 106, etc.

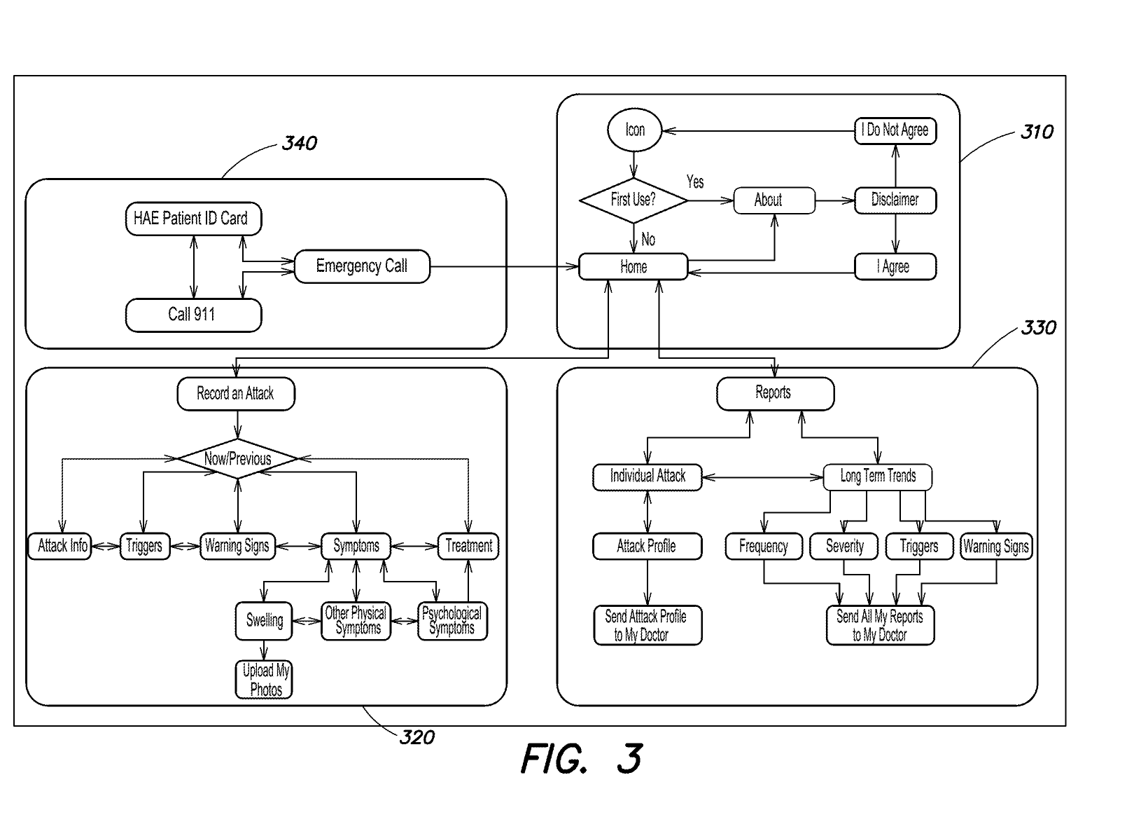

FIG. 3 illustrates a general architecture of a software application, program modules, or collection of instructions that describes functionality associated with some embodiments of the invention. It should be appreciated however, that the general architecture illustrated in FIG. 3 may be implemented in any suitable way including any combination of hardware and software. For discussion purposes, the architecture illustrated in FIG. 3 has been broken down into four subsections, each implementing functions associated with a scenario in which a user may interact with a user interface in accordance with some embodiments. When a user downloads an application and uses it for the first time, the user is often required to review one or more disclaimers or licenses regarding use of the application and acknowledge whether they consent to the terms in the disclaimer or license. An exemplary process for obtaining consent is represented by the blocks in scenario 310 of the architecture in FIG. 3, and will not be discussed in further detail as any suitable consent process may be used with embodiments of the invention.

After providing consent or if the user has previously used the application, a home page, such as home page 100 illustrated in FIG. 1 may be displayed on a user interface presented by the portable electronic device on which the application is executing. As discussed previously, a user may interact with a navigation selector to perform a task associated with the application as illustrated in the three remaining scenarios illustrated in the architecture of FIG. 3. In subsection 320, a user may interact with attack navigation selector 102 to record information about an attack, in subsection 330, the user may interact with report navigation selector 104 to request the generation of a report for one or more attacks, and in subsection 340, a user may interact with emergency navigation selector 106 to input or retrieve emergency information that may enable others to assist a patient in contacting emergency services, if necessary, during an attack. Each of subsections 320, 330, and 340 are described in more detail below with respect to figures that illustrate exemplary pages presented on a user interface in accordance with some embodiments of the invention.

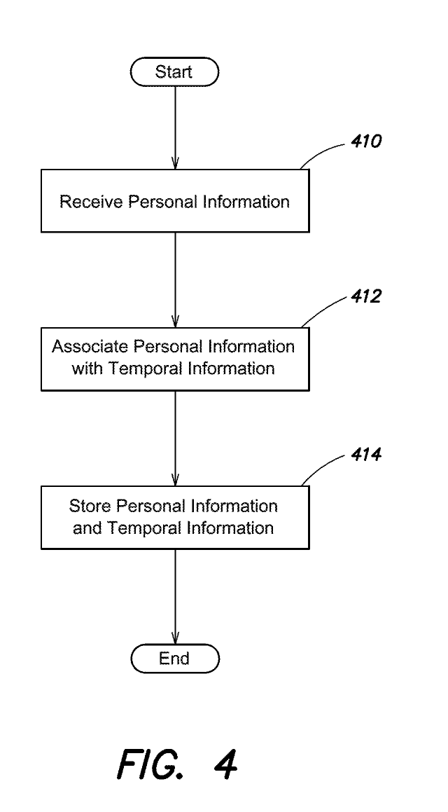

As discussed above, some embodiments are directed to collecting information related to an attack using a mobile application executing on a portable electronic device. FIG. 4 illustrates a flow chart of a process for collecting information in accordance with some embodiments of the invention. In act 410, personal information related to the attack is received from a user. As discussed above, personal information may include any type of information related to an attack including, but not limited to, information about triggers, observed warning signs, symptoms, and treatment. Once the personal information is received from a user, the process proceeds to act 412 where the personal information is associated with temporal information identifying, for example, a date and/or time of the attack. The temporal information may be determined by, for example, the user interacting with a user interface to identify information related to an onset of the attack. The temporal information may alternatively be identified in any other suitable way including, but not limited to, using information from a system clock of the portable electronic device.

The personal information may be associated with the temporal information in any suitable way and embodiments of the invention are not limited in this respect. For example, in some embodiments, personal information for each attack may be stored in a separate record of a structured or unstructured (e.g., XML file) database and temporal information may be associated with each record using any suitable method including, but not limited to, associating the temporal information by including temporal data as a portion of the record or by associating metadata corresponding to the temporal information with the record.

After the personal information is associated with temporal information, the process proceeds to act 414 where the personal information and the temporal information is stored in a storage medium associated with the portable electronic device. In some embodiments, all data including personal and temporal information may be stored locally in one or more storage mediums of the portable electronic device. However, in other embodiments at least a portion of the data may be stored in a storage medium located outside of the portable electronic device. For example, the data may be stored on a server that is connectable to the portable electronic device via one or more networks. Additionally, the associated personal and temporal information may be stored in any suitable format such that the data may be retrieved, revised, and used to generate one or more reports, as discussed in more detail below. A further discussion of collecting personal information for an attack in accordance with some embodiments is discussed in more detail below.

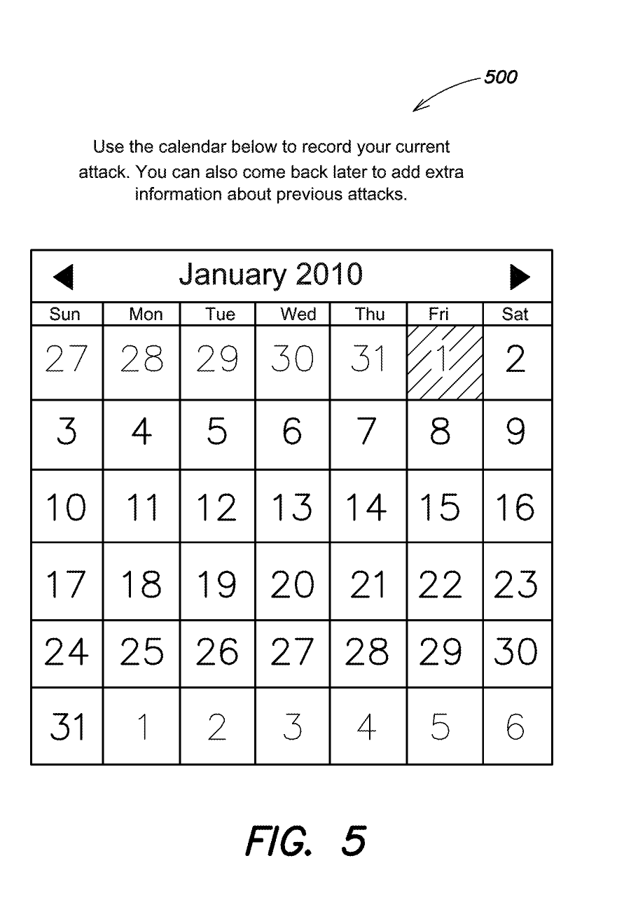

In some embodiments a user may input personal information to describe one or more aspects of an attack by interacting with attack navigation selector 102 displayed on home page 100. In response to selecting attack navigation selector 102, the application may navigate to a temporal information page 500 as shown in FIG. 5. After navigating to temporal information page 500, the user may be prompted to select a date corresponding to the onset of the attack for which the user wants to record information. Alternatively, the temporal information selected by a user may correspond to any affect associated with an attack including, but not limited to, a time associated with the peak severity of the attack. As shown in FIG. 5, temporal information page 500 may display an interactive calendar to enable the user to select a particular day to associate with the attack. In some embodiments, days on which information has already been reported may be highlighted or otherwise marked on the calendar to indicate the existence of stored information for an attack on that day.

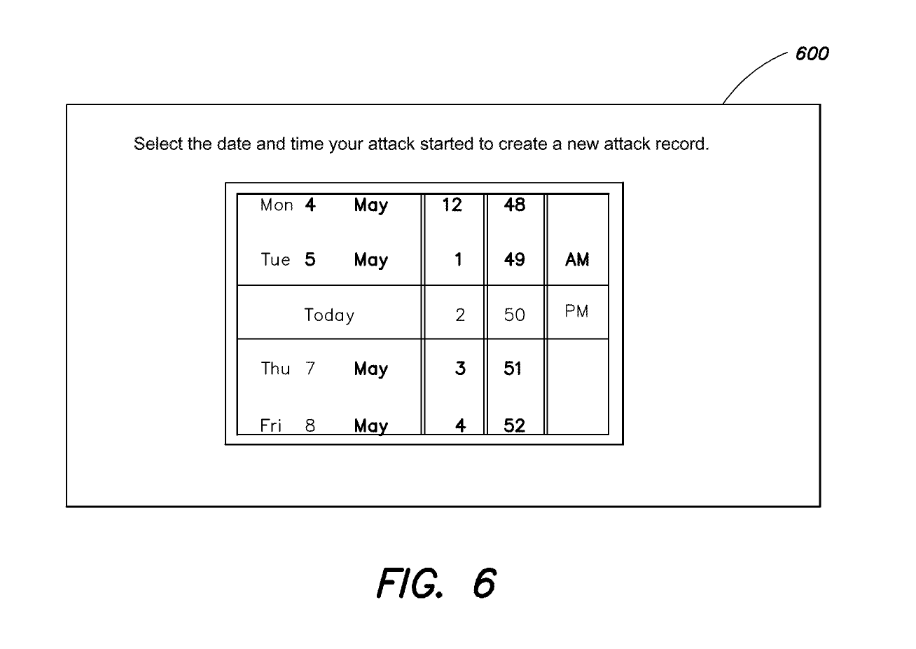

It should be appreciated that any suitable temporal information selector may be used and the example of a calendar in FIG. 5 is provided for exemplary purposes only. For example, FIG. 6 illustrates an alternative embodiment that displays an interactive temporal dial 600 rather than a calendar with which the user can interact to select temporal information. Alternatively, any other suitable user interface components, such as drop down menus, text boxes, radio buttons, etc., may be used on a temporal information page to enable the user to specify temporal information. Additionally, the temporal information may include date information, time information, or both date and time information and embodiments of the invention are not limited in this respect.

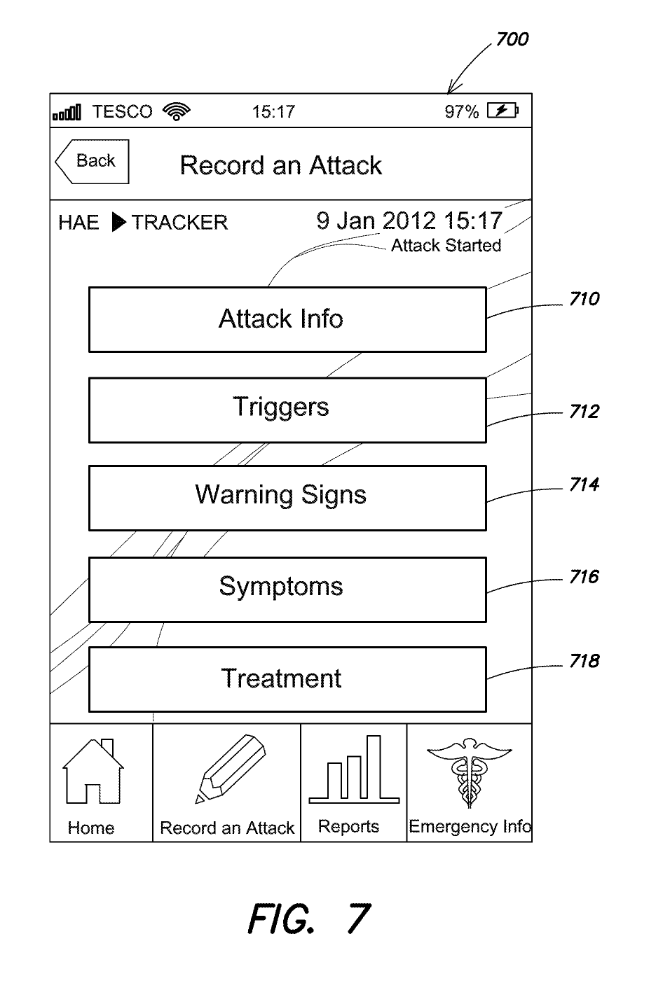

After specifying temporal information indicating the onset of the attack, the display may be updated to present a recording page 700 including a plurality of recording selectors as shown in FIG. 7, wherein the recording selectors, when selected by the user, enable the user to interact with one or more interactive fields to input personal information characterizing aspects of the attack.

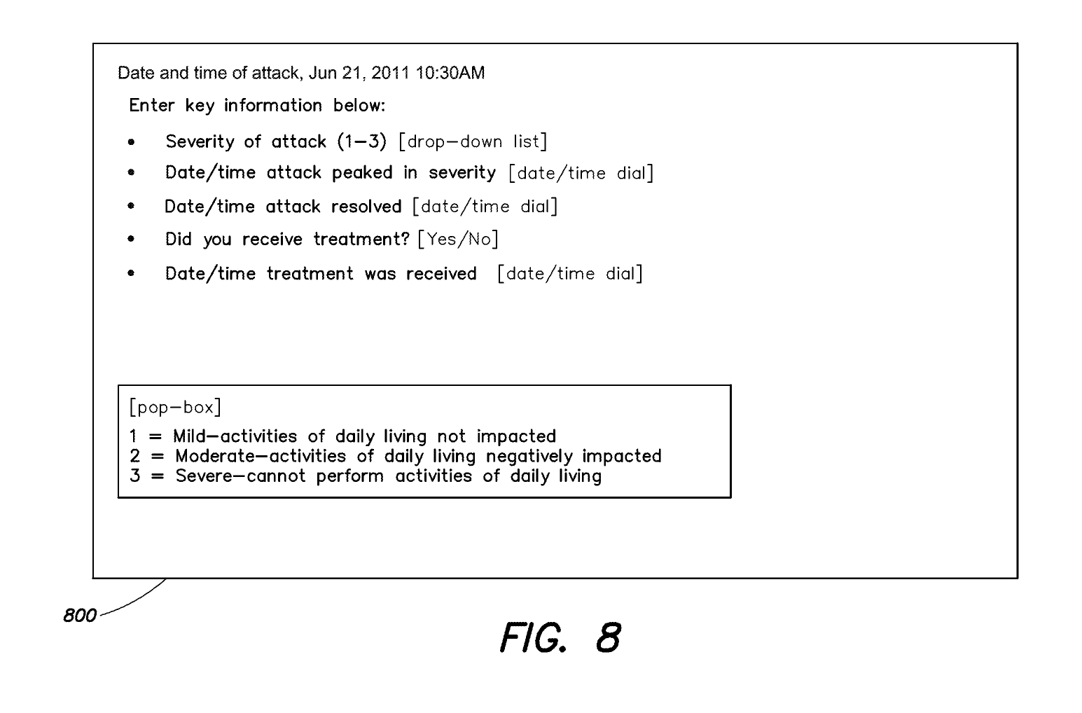

For example, recording page 700 may include attack information selector 710 that, when selected by a user, results in the display of attack information page 800 as shown in FIG. 8. Attack information page 800 may include a plurality of user interface components such as drop-down menus, date/time dials, yes/no selectors, pop-up boxes, etc., that enable a user to enter general information about the attack. For example, the exemplary attack information page 800 shown in FIG. 8 enables the user to enter information about the severity of the attack, whether the user received treatment for the attack, and additional temporal information related to the attack, such as when the attack peaked in severity, when the attack resolved, and when treatment was received, if at all. In some embodiments, the user may be prompted to rate one or more of these factors on a scale (e.g., 1-3) and explanations associated with the ratings may also be included on attack information page 800. Any other suitable information relating to general aspects of the attack may be recorded on attack information page and embodiments of the invention are not limited in what information is collected or on which particular page information is entered. Information input using one or more of the interactive fields on attack information page 800 is stored as personal information as discussed above.

Information related to other aspects of the attack may also be recorded by interacting with one or more of the recording selectors on recording page 700. As discussed above, attacks may be triggered by certain behaviors or factors that, when experienced by the user, tend to exacerbate the occurrence of attacks. For example, stress and trauma are two common triggers for attacks reported by patients diagnosed with HAE. By identifying the triggers that tend to commonly result in subsequent attacks, patients with HAE may be in a better position to avoid situations involving such triggers, if possible.

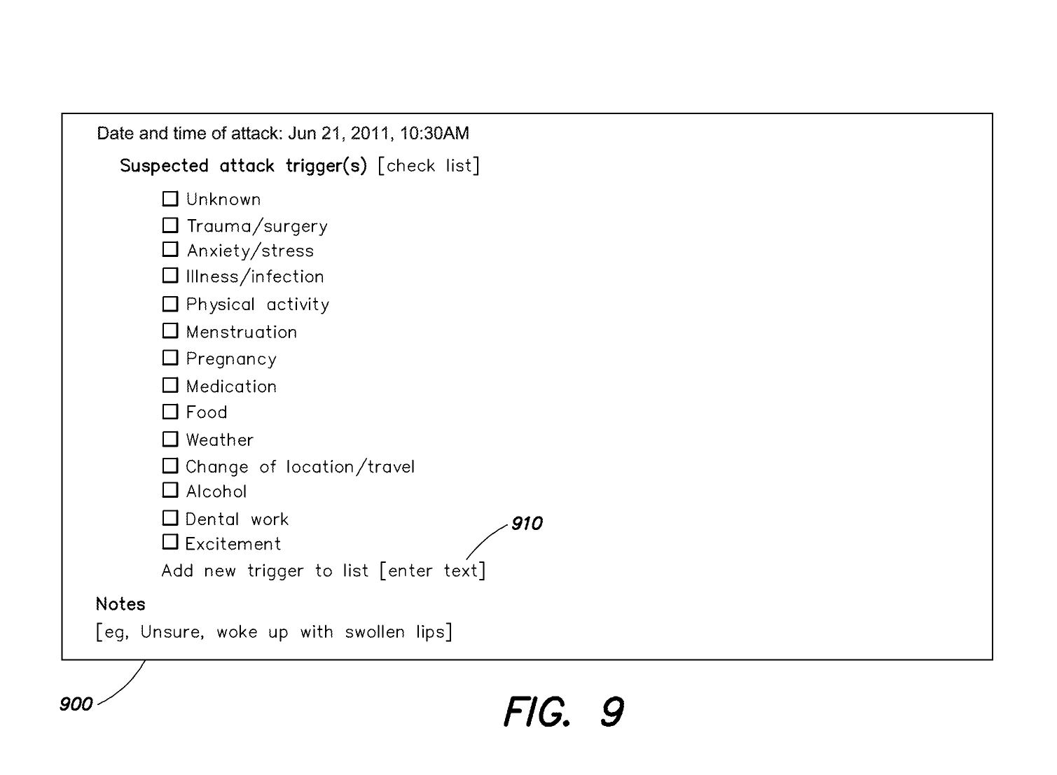

In accordance with some embodiments, a user may interact with trigger selector 712 to enable the user to enter personal information related to one or more suspected triggers associated with the attack. In response to detecting a selection of trigger selector 712, the display on the portable electronic device may be updated to display trigger page 900 as shown in FIG. 9. Trigger page 900 may include a checklist of commonly reported triggers for a particular disease, such as HAE.

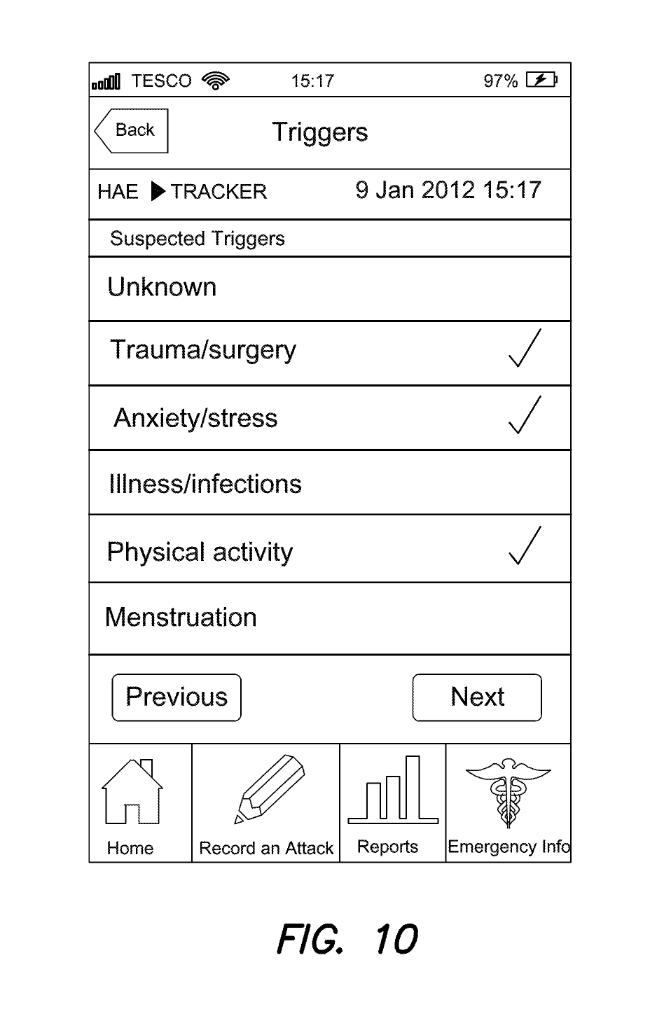

In some circumstances, the user may determine that the suspected trigger they wish to record is not on the displayed list of suspected list of triggers. In these circumstances, a user may interact with new trigger selector 910 to enable the user to input a name to associate with the new trigger. In some embodiments, new trigger selector 910 may include a textbox with which a user may interact to add a new suspected trigger to the list. In other embodiments, in response to interacting with new trigger selector 910, the application may navigate to new trigger page 1000, an example of which is shown in FIG. 10, that includes one or more user interface components with which the user may interact to specify a name for the new suspected trigger. In response to saving the new trigger name, a suspected trigger may be added to the list to enable the user to select it.

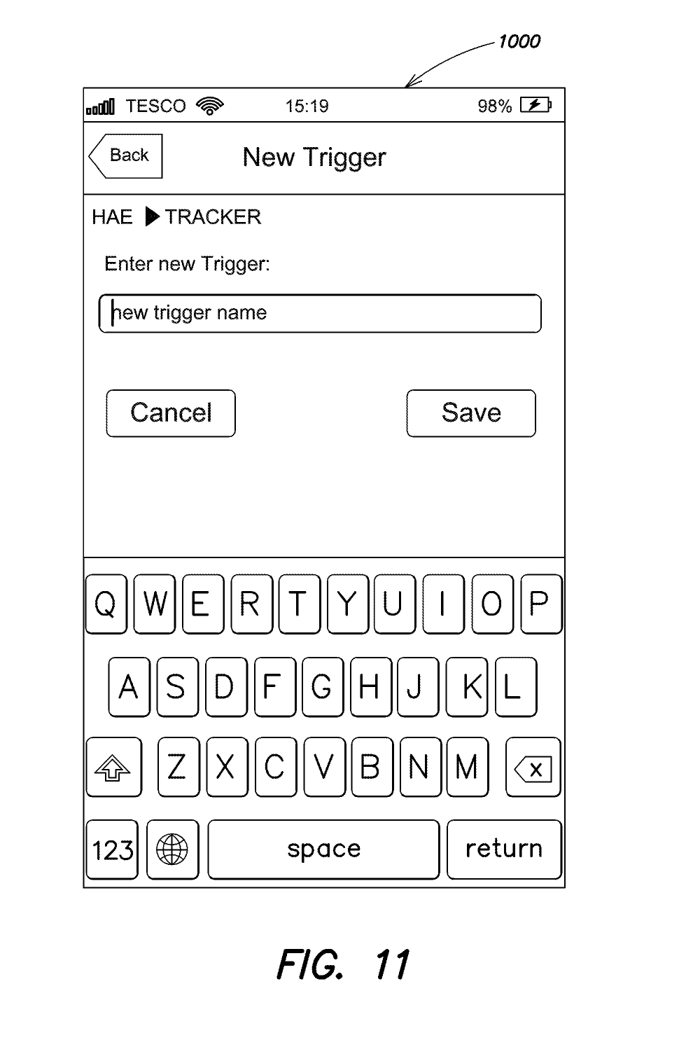

In some embodiments, trigger page 900 may include a free-form notes section with which a user may interact to record any additional information about suspected triggers for the attack. FIG. 11 illustrates an alternative user interface for trigger page 900 on which a checklist is displayed using checkmarks rather than checkboxes as shown in the embodiment of FIG. 9. Information input by a user using one or more of the interactive fields on trigger page 900 may be stored as personal information as discussed above.

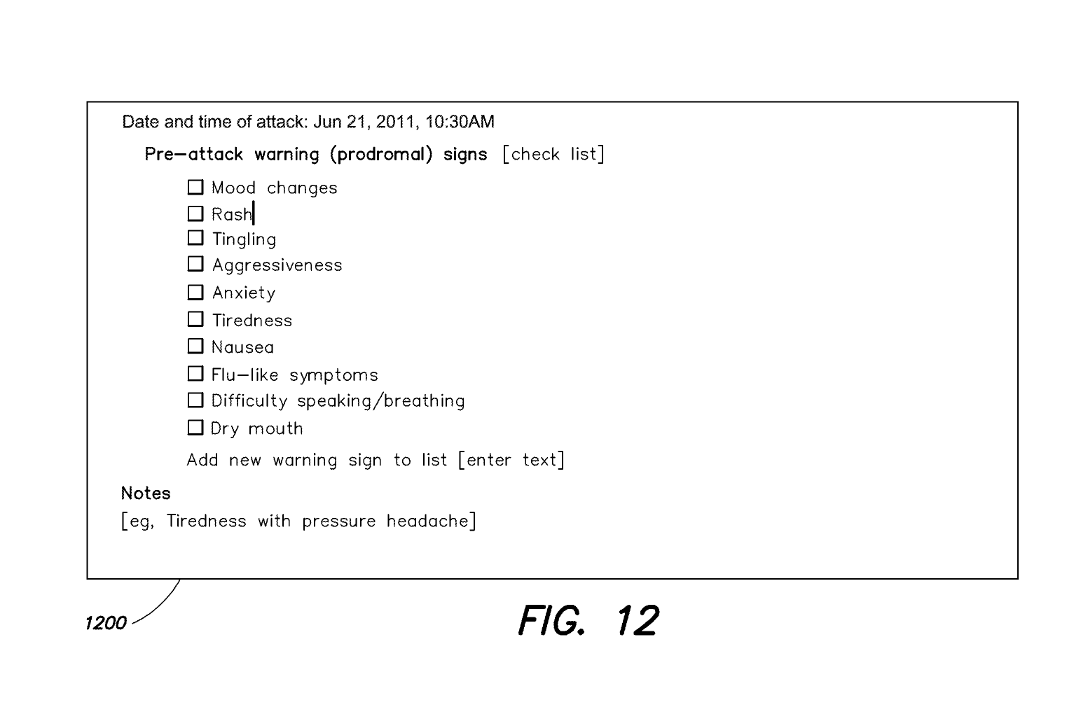

Some diseases may be associated with attacks that are preceded by one or more pre-attack warning (or “prodromal”) signs indicating that an attack is likely to occur in the near future. For example, patients with HAE often report seeing skin irritations such as rashes on certain parts of their body in advance of an attack. In some embodiments, information related to warning signs prior to an attack may be recorded by interacting with warning sign selector 714 on recording page 700. In response to a selection of warning sign selector 714, the application may navigate to warning sign page 1200, an example of which is shown in FIG. 12. Warning sign page 1200 may include a plurality of selectable fields for identifying one or more physical warning signs that were observed by the user prior to the attack. Similar to the capabilities described above regarding adding a new suspected trigger, some embodiments may enable a user to add new warning signs not currently reflected in the list of selectable warning signs. New warning signs may be added in any suitable manner and embodiments of the invention are not limited in this way. Warning sign page 1200 may also include a free-form notes section that enables a user to input additional notes about warning signs that are not captured by selections in the list of selectable warning signs.

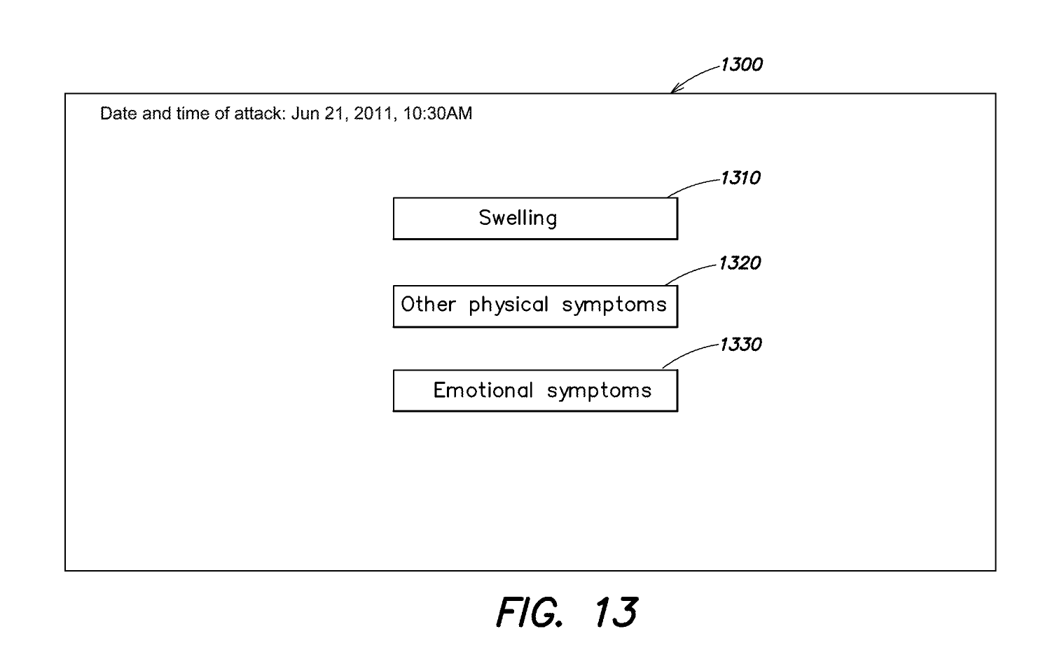

Other personal information that may be recorded for an attack includes symptoms that the user observed or experienced during the attack. The below-described example of recording symptoms relates to HAE attacks, although it should be appreciated that a similar symptom recording process may be used with other diseases characterized by occasional or frequent attack episodes. To record symptoms, a user may interact with symptoms selector 716 on selector page 700, which may result in the application navigating to symptom page 1300, an example of which is shown in FIG. 13. In some embodiments, different types of symptoms may be recorded using different pages of the application although it should be appreciated that symptom information may be collected in any suitable manner. As shown in FIG. 13, symptom page 1300 may include swelling selector 1310, physical symptom selector 1320, and psychological selector 1330. Each of these selector, when selected by a user may cause the application to navigate to a page to enable the user to enter symptom information corresponding the particular symptom type that was selected.

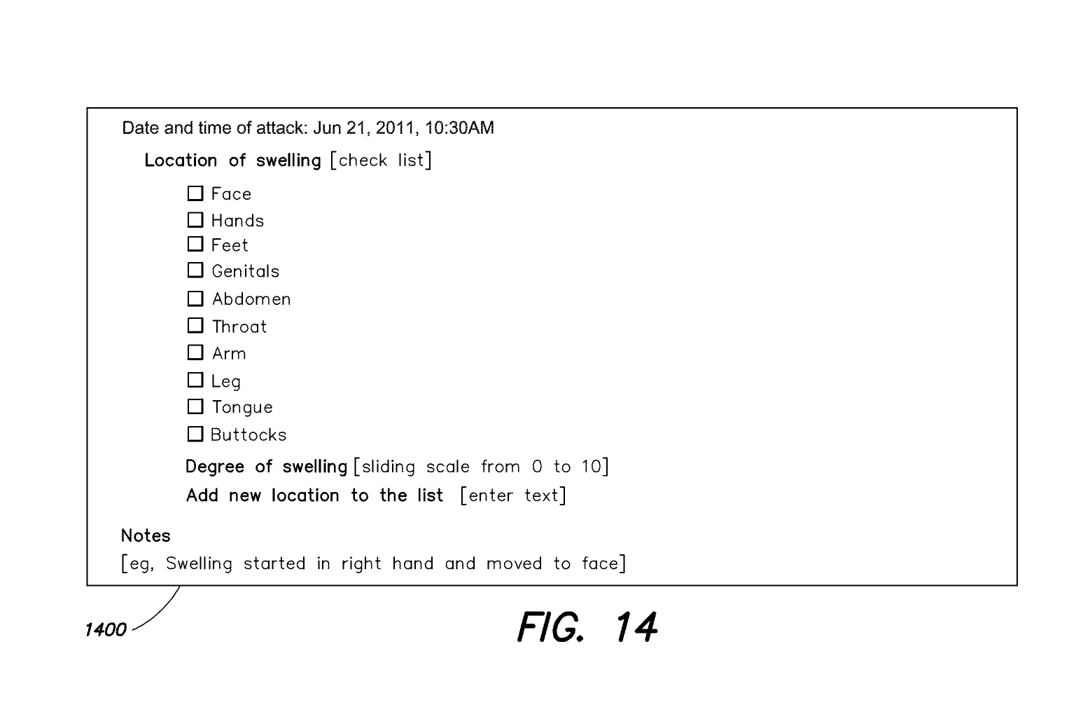

Attacks in patients diagnosed with HAE often include swelling as the most readily identifiable symptom associated with an attack. A user may record personal information about swelling during the attack by interacting with swelling selector 1310, which results in navigation to swelling page 1400, an example of which is illustrated in FIG. 14. Swelling page 1400 may include a checklist or other plurality of selectable fields that enables a user to identify one or more body regions in which swelling occurred during the attack. Additionally, swelling page 1400 may include a field for allowing a user to specify a degree of swelling during the attack. The degree of swelling may be a general degree of swelling during the attack or the degree of swelling may be associated with particular body regions that are selected. As with other pages discussed earlier, swelling page 1400 may include a free-form notes section that enables a user to add other notes related to symptoms during the attack. For example, as shown in FIG. 14, the notes may be used to indicate a progression of swelling from one body region to another body region. Information input in the one or more interactive fields of swelling page 1400 is saved as personal information as discussed above.

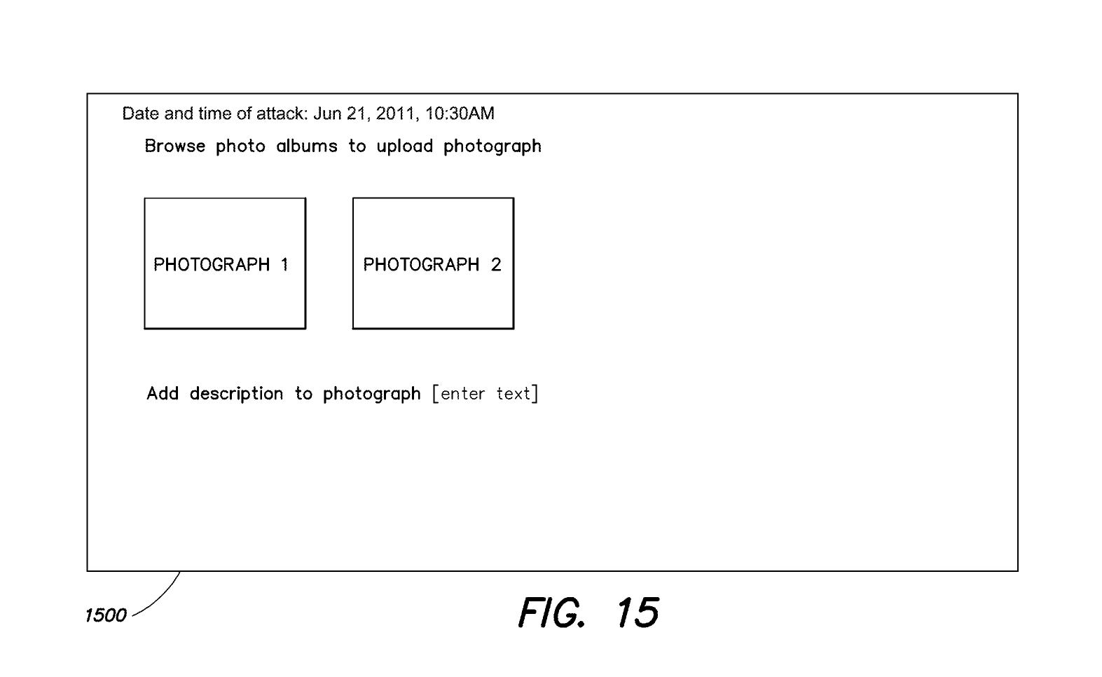

Many modern portable electronic devices include a built-in camera that may be used to take photographs of symptoms during an attack. In some embodiments, one or more photographs depicting portions of the user's body that have swollen during the attack may be saved as personal information associated with the attack. In response to a request by a user to record a photograph as personal information, the application may navigate to photograph upload page 1500, an example of which is shown in FIG. 15. The user may interact with photograph upload page 1500 to browse a photograph repository stored on the portable electronic device to identify one or more photographs to record as personal information for the attack. Additionally, the user may interact with one or more fields on photograph upload page 1500 to add a description to one or more of the uploaded photographs. In some embodiments, the digital file containing the photograph may be copied from the photograph repository from which it was selected to another location associated with recorded personal information for the attack, although in other embodiments, a link associated with the original location of the photograph may be recorded as personal information associated with the attack.

Any suitable number of photographs may be recorded as personal information for the attack. For example, a user may want to describe to their physician a progression of swelling that happened during the attack and the user may upload a series of photographs illustrating the progression. In addition to recording photographs for illustrating symptoms such as swelling, photographs describing other information including, but not limited to, warning signs may also be recorded as personal information associated with the attack in accordance with some embodiments of the invention.

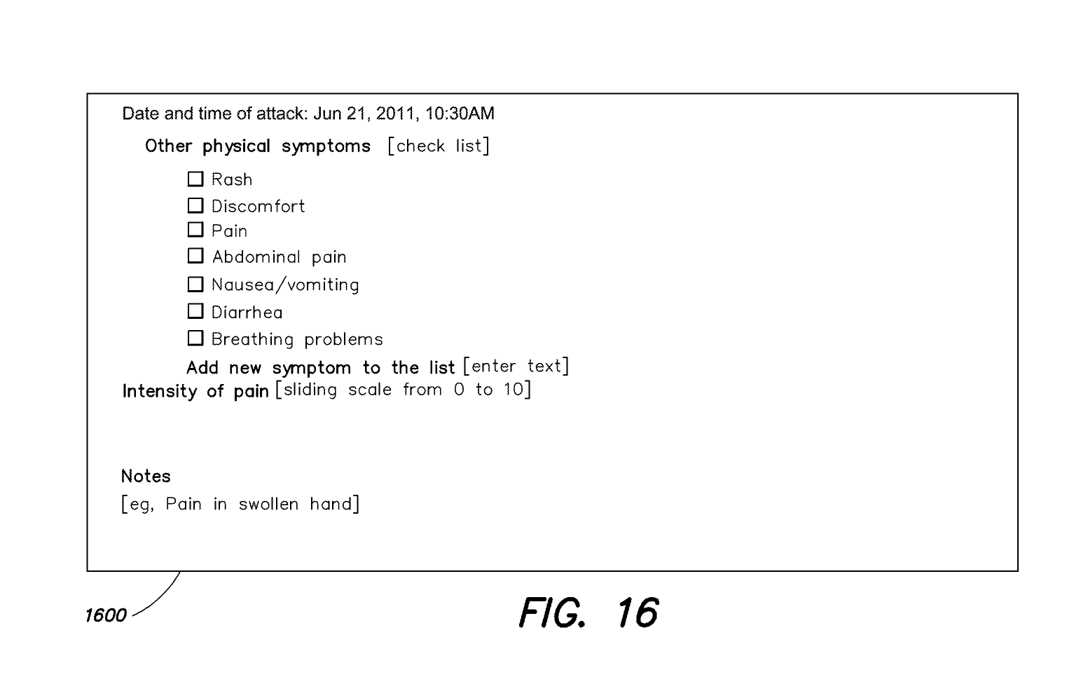

In addition to swelling symptoms, a user may want to record other physical symptom information associated with the attack. Accordingly, in response to interacting with physical symptom selector 1320 on symptom page 1300, the user may operate the application to navigate to physical symptom page 1600, an example of which is illustrated in FIG. 16. Physical symptom page 1600 may include a checklist of commonly occurring physical symptoms associated with a particular disease and a user may interact with one or more of the items in the checklist to specify physical symptoms the user experienced during the attack. Patients with HAE often report pain as the most common symptom second to swelling. Accordingly, physical symptom page 1600 may include an interactive field that enables a user to indicate an intensity of pain experienced during the attack. As with many of the other pages described herein, physical symptom page 1600 may include a free-form notes section to enable a user to enter more specific information regarding physical symptoms during the attack. Information input using one or more of the interactive fields on physical symptom page 1600 are stored as personal information associated with the attack as described above.

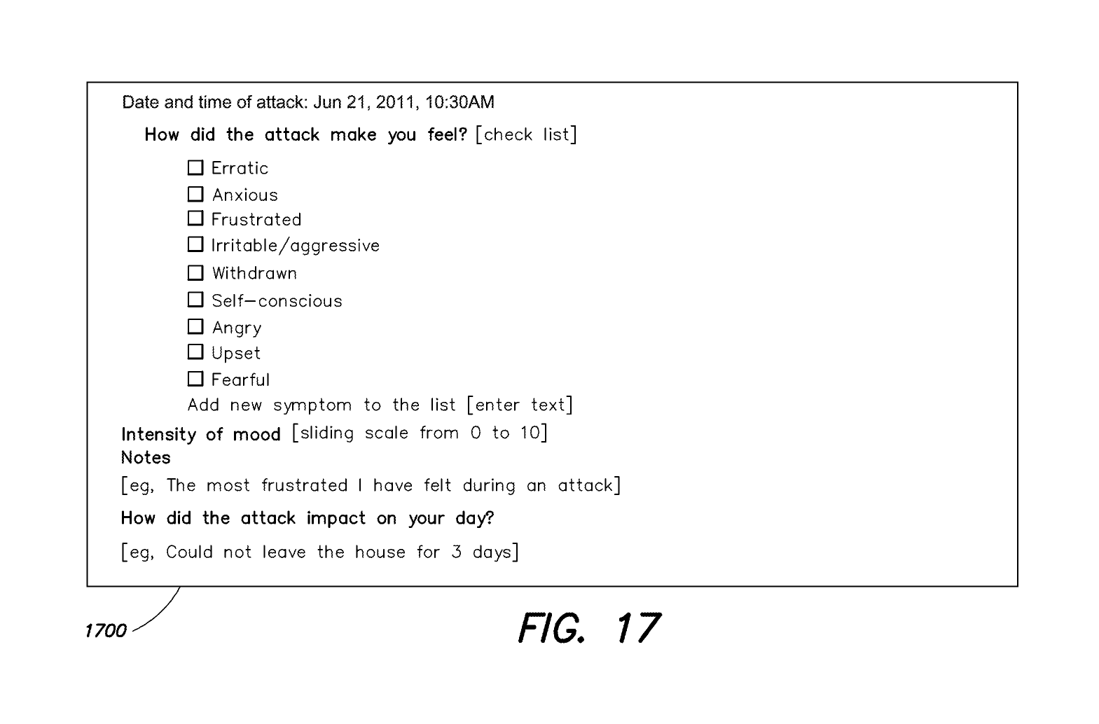

Often, physical symptoms are accompanied by psychological symptoms that affect a patient's mood and/or quality of life following an attack. In response to interacting with psychological symptom selector 1330 on symptom page 1300, the application may navigate to psychological symptom page 1700, an example of which is shown in FIG. 17. Psychological symptom page 1700 may include an interactive checklist with which a user may interact to select one or more symptoms associated with the user's mood following the attack. Additionally, psychological symptom page 1700 may include an interactive field for indicating an intensity of the mood that was experienced during and/or after the attack. In some embodiments, psychological symptom page 1700 may also include one or more questions designed to elicit personal information related to the user's psychological condition following the attack. Other personal information regarding the user's psychological condition may also be input using one or more interactive fields displayed on psychological symptom page 1700 and embodiments of the invention are not limited in this respect. Information input using one or more of the interactive fields on psychological symptom page 1700 may be stored as personal information associated with the attack as described above.

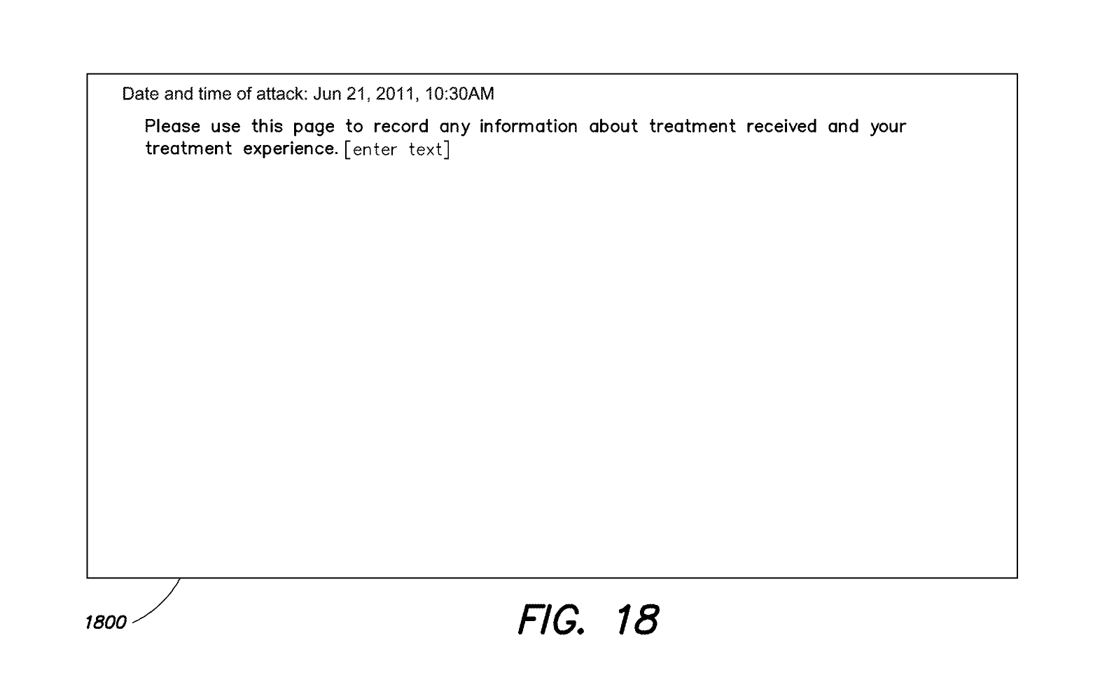

Attacks in a disease such as HAE are not entirely preventable, although effective treatment is available to decrease the severity of the symptoms and to speed recovery after an attack has occurred. Accordingly, in some embodiments, a user may want to record information about the treatment that was received, if any, following an attack to help determine which treatment options are most effective for the particular patient. To record treatment information, a user may interact with treatment selector 718 on selector page 700. In response to determining that the user has selected treatment selector 714, the application may navigate to treatment information page 1800, an example of which is shown in FIG. 18. Treatment page 1800 may include one or more interactive fields to enable a user to enter information about treatment received after an attack. Additionally, while not shown in the exemplary treatment page 1800 of FIG. 18, treatment page 1800 may include one or more questions designed to elicit information about treatment received by the patient, if applicable.

As discussed above, users may choose to cycle through the pages described above for collecting information associated with an attack in a step-by-step fashion by using next and previous navigation selectors displayed on each page. However, users are not restricted to inputting information in a step-by-step fashion and some information may be entered using a graphical interface during one session, while additional information or modified information may be entered into the graphical interface during another session. For example, rather than entering information for a new attack, a user may request to modify information for an attack that includes previously-stored information. In response, the previously-stored information associated with the selected attack may be retrieved and the information may be modified and/or additional information may be added to supplement the previously-stored information. After the user has finished modifying the information for the attack, the modified information may be stored as personal information associated with the attack as described above.

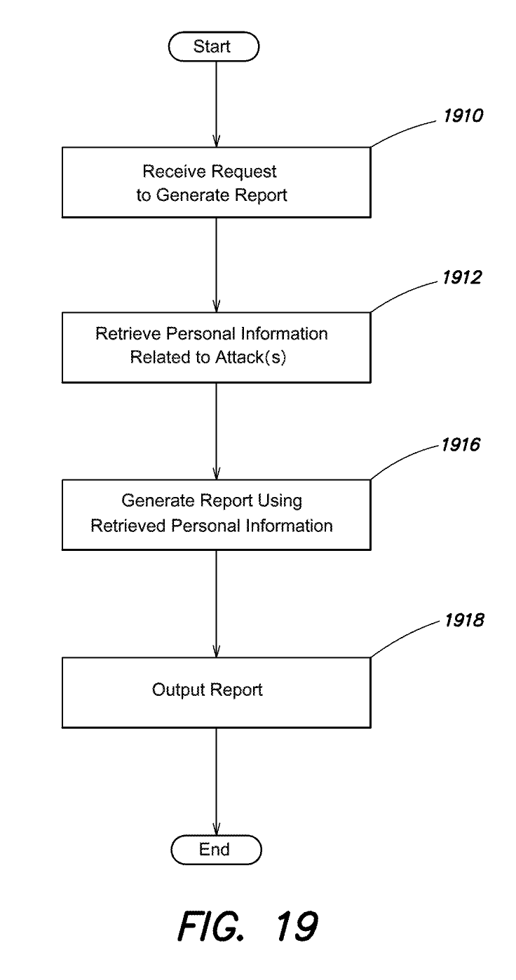

Some embodiments are directed to generating one or more reports based, at least in part, on personal information stored on a portable electronic device. FIG. 19 illustrates an exemplary process for generating a report in accordance with some embodiments of the invention. In act 1910, a request is received from a user to generate a report for one or more attacks. For example, as described above, a user may interact with a report selector displayed as a portion of a user interface to indicate that the user wants to generate a report.

In response to receiving the request to generate a report, the process may proceed to act 1912, where personal information related the one or more attacks is retrieved from at least one storage medium associated with the portable electronic device. The personal information may be stored locally by the portable electronic device or at least some of the personal information may be stored remote from the portable electronic device by, for example, a server connected to the portable electronic device over a network.

In response to retrieving the personal information, the process proceeds to act 1916 where the report is generated based, at least in part, on the personal information. The report may be generated in any suitable way. For example, the portable electronic device may include one or more processors that process the retrieved personal information by aggregating at least some of the information and/or deriving one or more report metrics from the retrieved personal information. As discussed in further detail below, if the user has requested a report for a single attack, the type of report that is returned may be different than if the user has requested a report related to multiple attacks occurring during a specified time period (e.g., one year).

After generating the report, the process proceeds to act 1918 where the generated report is output (e.g., displayed on the display of the portable electronic device, stored, sent to another device). Other operations including, but not limited to, sending the report to one or more other users (e.g., the patient's physician) are discussed in more detail below.

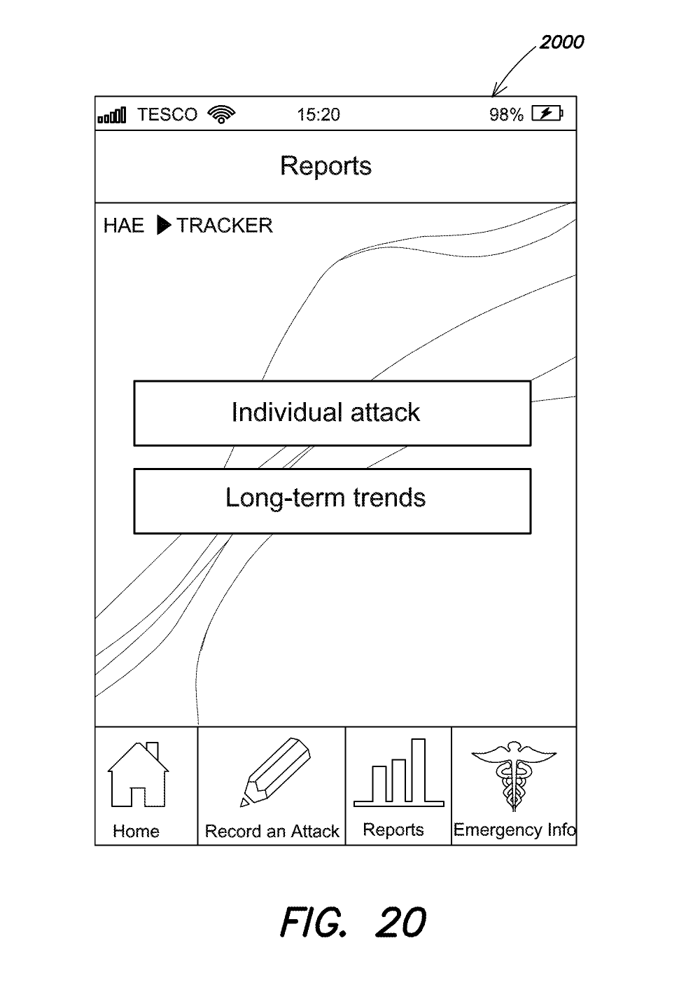

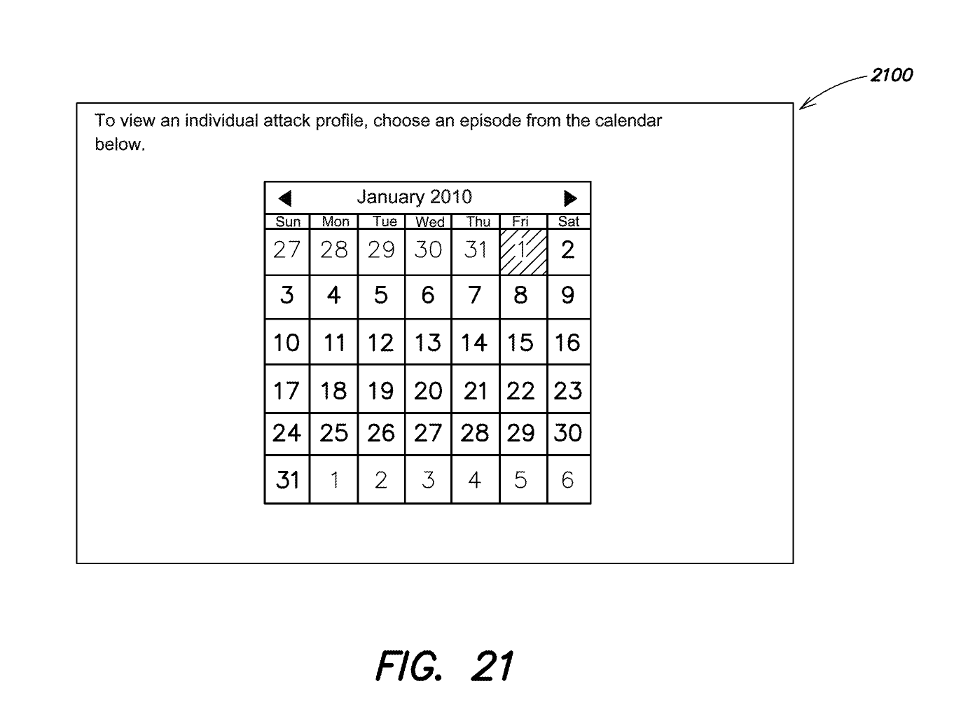

In response to receiving a request to generate a report by, for example, determining that a user has interacted with report navigation selector 104 on home page 100, the application may navigate to report page 2000, an example of which is illustrated in FIG. 20. On report page 2000, the user may be prompted to select whether the report is for a single attack episode or for multiple attack episodes occurring during a time period. In response to the user selecting a report for a single attack episode, the application may navigate to episode selection page 2100, an example of which is shown in FIG. 21. Episode selection page 2100 may include an interactive selection component that enables a user to identify a particular attack episode for the report, such as by selecting a date and/or time for the episode. For example, the exemplary episode selection page 2100 in FIG. 21 includes an interactive calendar with which a user may interact to select a day on which the episode occurred.

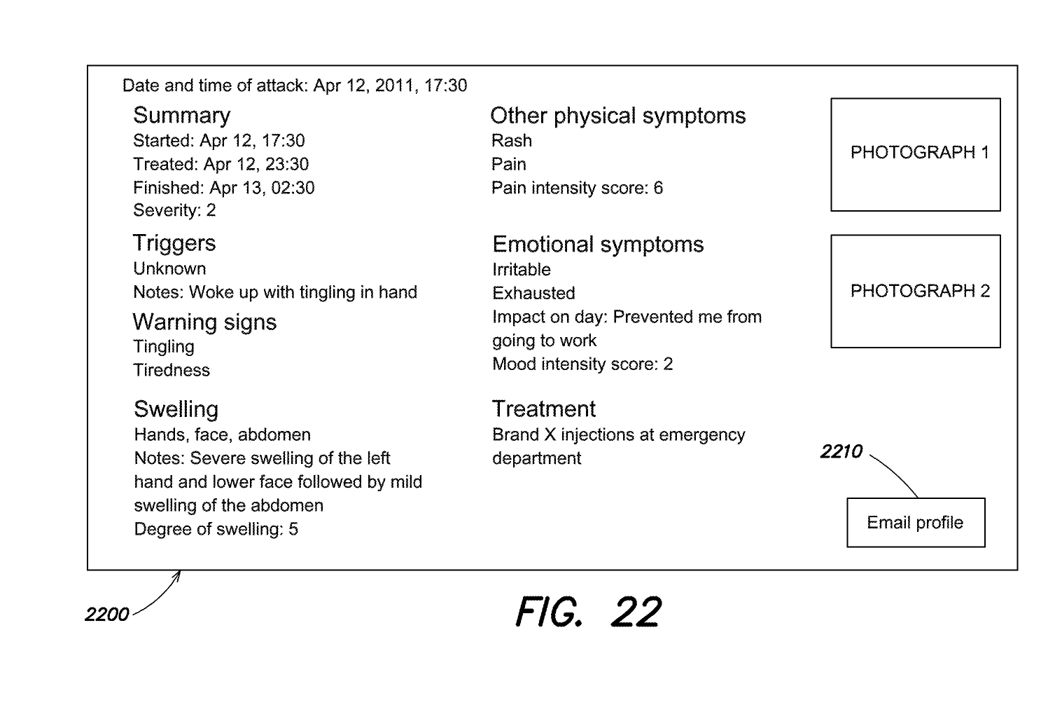

In response to receiving a selection that identifies the particular attack episode for generating the report, the stored personal information associated with the selected attack episodes is retrieved from storage and is formatted into an attack profile 2200 that is displayed to the user, as illustrated in FIG. 22. The attack profile 2200 may include a summary of various characteristics related to the attack episode that the user had previously recorded using the recording pages discussed above. Such summaries may be helpful in explaining a patient's experiences with his or her physician during a patient visit.

In some embodiments, attack profile 2200 may include an interactive communication selector 2210 that, when selected, enables the user to send the attack profile to another user (e.g., the patient's physician, off-device storage, etc.). The information in the attack profile may be sent to the other user in any suitable format such that the other user may not be required to access the attack profile using a particular mobile application as described herein. For example, in some embodiments, the information in the attack profile may be formatted and sent in an email to the other user so the other user may access the information using any suitable email application.

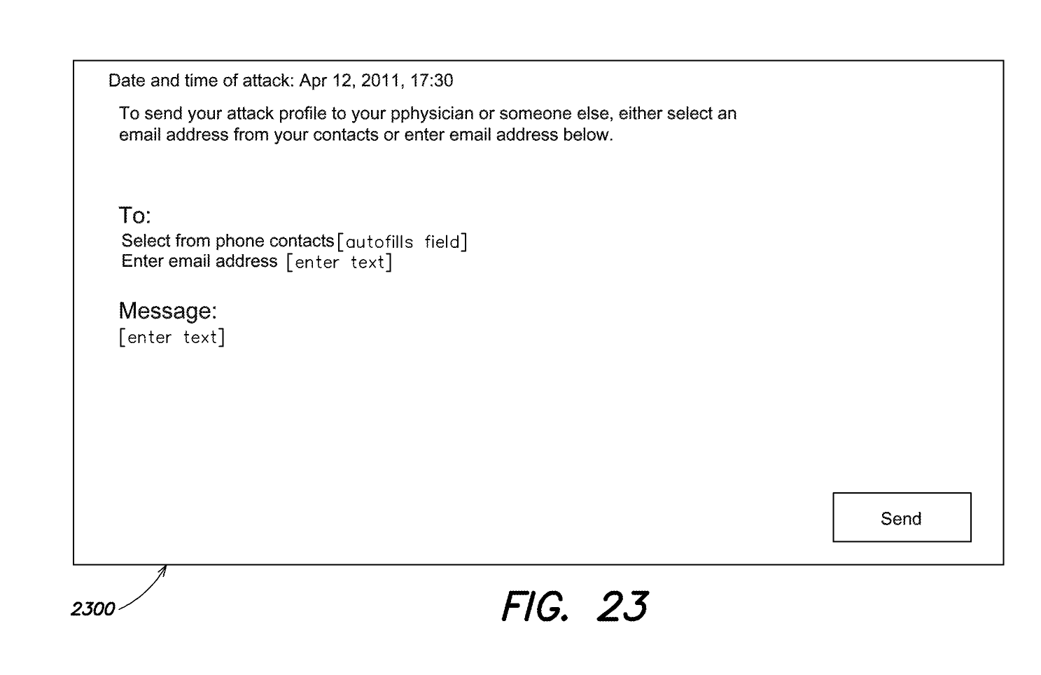

In response to determining that the user has selected communication selector 2210, the application may navigate to communication page 2300, an example of which is shown in FIG. 23. Communication page 2300 may include one or more interactive fields to enable the user to specify a recipient for the attack profile and to add additional information, if desired. In response to entering information into communication page 2300 and indicating that the communication should be sent to the selected contact, a message may be sent to the selected contact in any suitable manner. For example, in some embodiments, an email is generated that includes the attack profile and any other information specified on communication page 2300 and the generated email is transmitted to the selected contact.

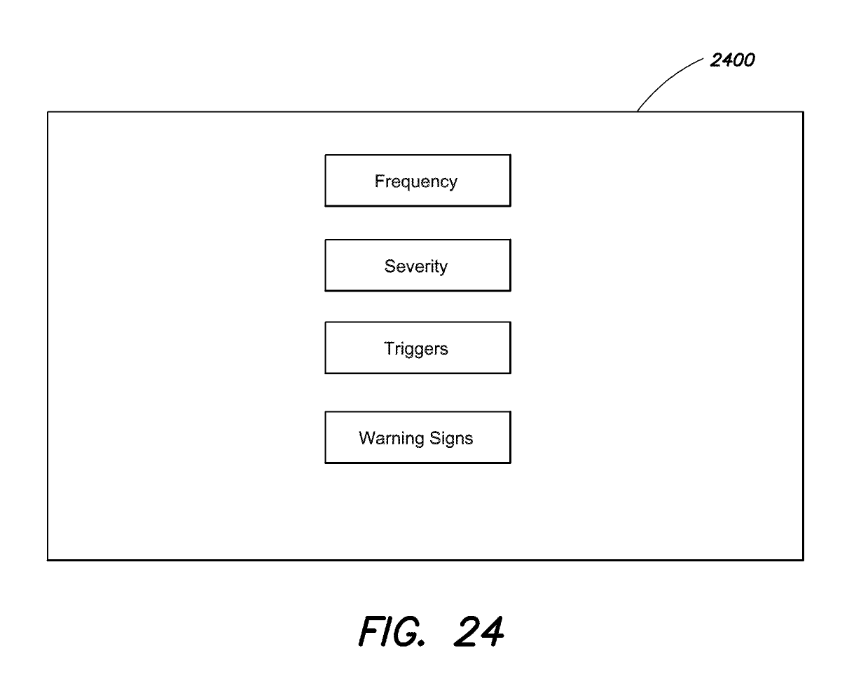

As discussed above, in some embodiments, a report may be generated based, at least in part, on personal information stored for a plurality of attack episodes and one or more report metrics determined based on the personal information may be determined and output as at least one graphical illustration. In response to a user initiating a request for a report based on multiple attack episodes during a time period, the application may navigate to a report metric selection page 2400, an example of which is illustrated in FIG. 24. Report metric selection page 2400 may be configured to prompt a user to select a report metric used as a basis for generating the report. For example, exemplary report metric selection page 2400 shown in FIG. 24 includes four metrics: frequency of attacks, severity of attacks, types of suspected triggers, and types of warning signs. Although only four report metrics are shown, it should be appreciated that any suitable report metric may be used in accordance with embodiments of the invention. For example, reports based on a duration of symptoms for attacks, the effectiveness of particular treatments, and many other types of report metrics may also be determined.

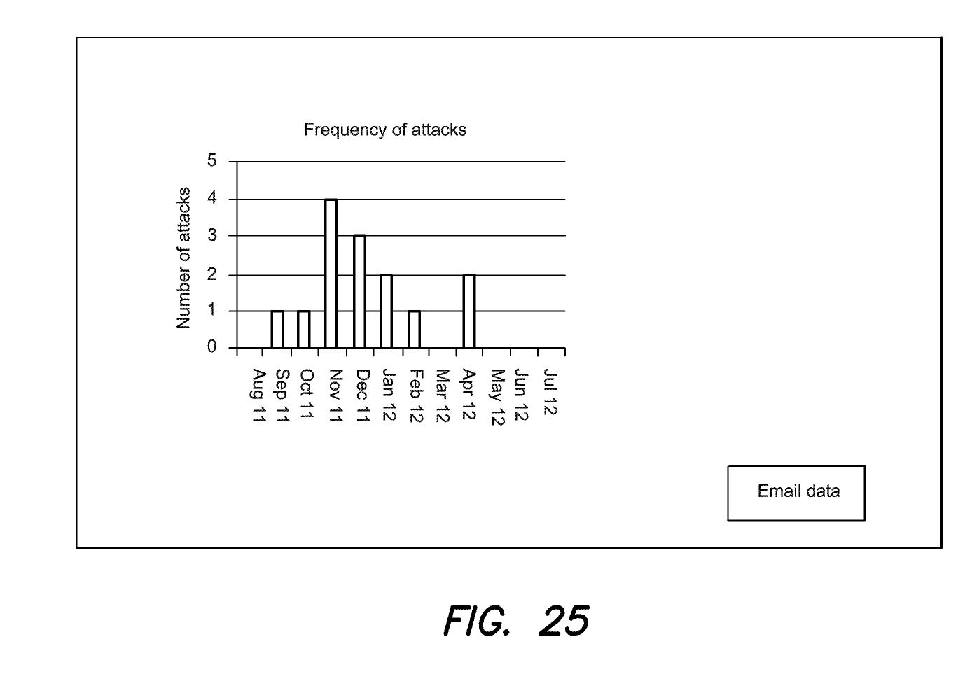

In response to receiving a selection of one of the report metrics displayed on report metric selection page 2400, personal information related to one or more attacks is aggregated based, at least in part, on the selected report metric to generate at least one graphical representation for the report. Examples of graphical representations corresponding to each of the exemplary report metrics shown in FIG. 24 are illustrated in FIGS. 25-28.

FIG. 25 illustrates a graphical representation for a frequency of attacks report metric determined over a one year time period. In some embodiments, a user may specify a different time period during which the frequency of attack episodes is determined. The frequency of attacks may be determined in any suitable way. For example, temporal information associated with each of the attacks stored in the at least one storage medium associated with the portable electronic device may be searched to identify all attack episodes with onsets within a specified time period.

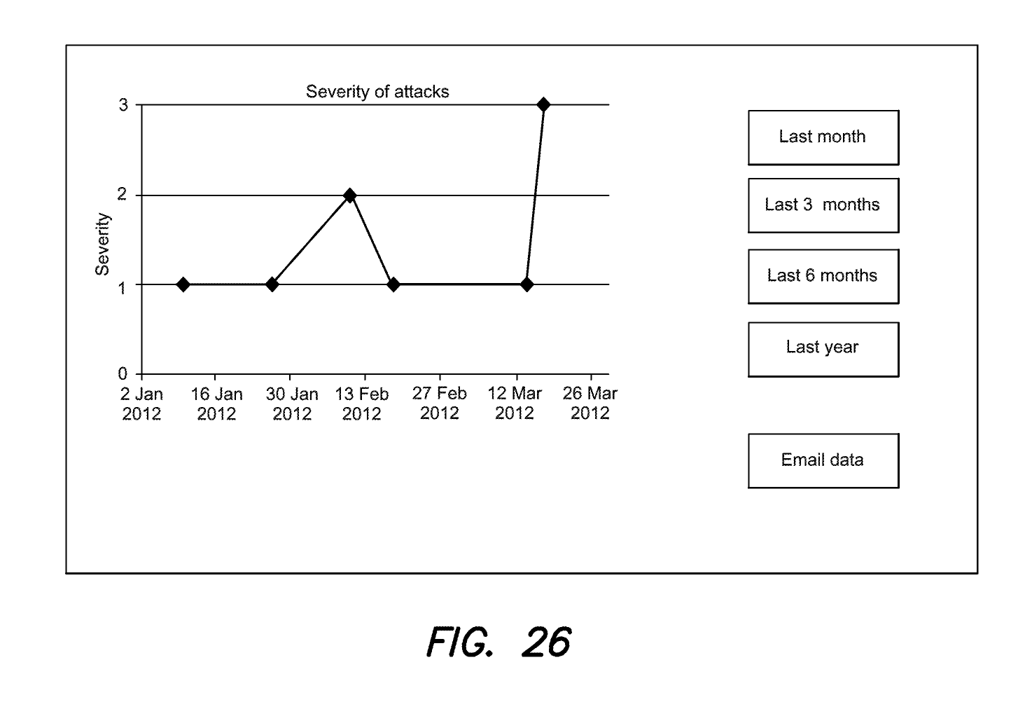

FIG. 26 illustrates a graphical representation for a severity of attacks report metric determined over a one year time period. FIG. 26 also illustrates a plurality of time period selectors, with which a user may interact to select a different time period during which to determining the severity of attacks metric.

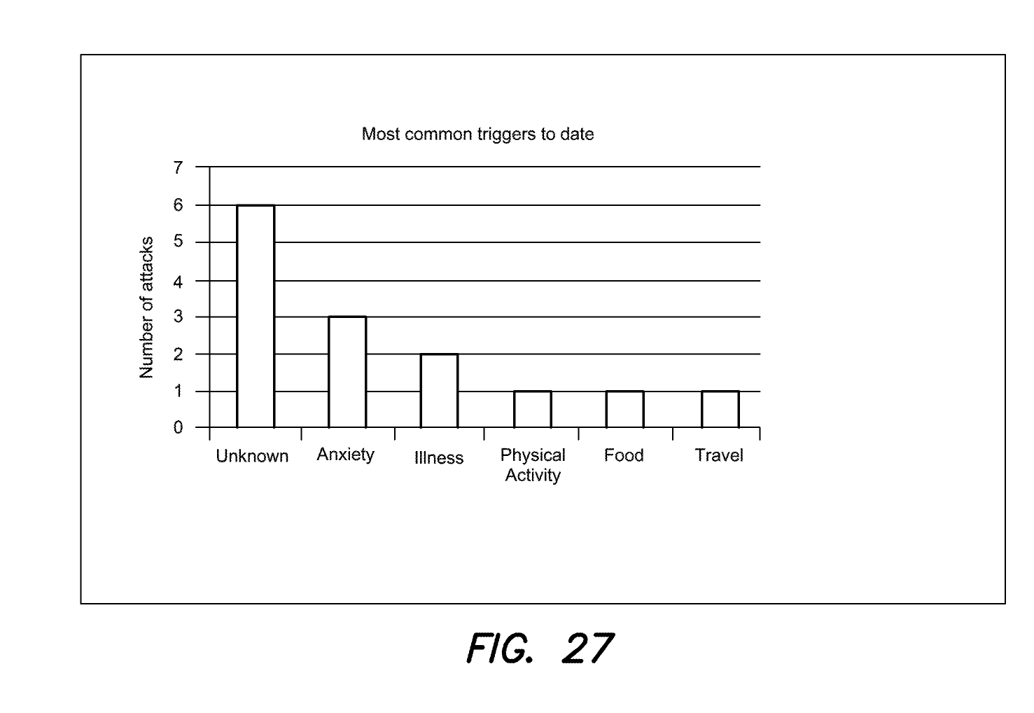

FIG. 27 illustrates a graphical representation for a commonly reported trigger report metric. Although the exemplary graphical representation in FIG. 27 includes all recorded triggers up to the current time when the request for the report was generated, it should be appreciated that any of the report metrics used in accordance with embodiments of the invention may be time limited in any suitable manner and embodiments of the invention are not limited in this respect.

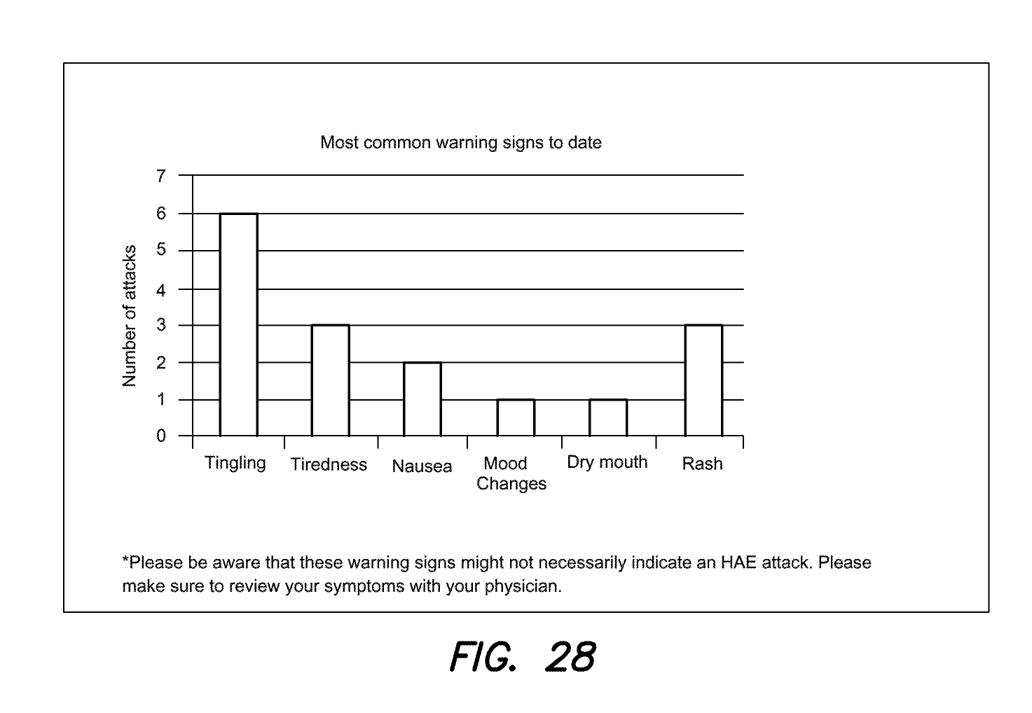

FIG. 28 illustrates a graphical representation for a commonly reported warning signs report metric. As discussed above with the trigger metric shown in FIG. 27, although the exemplary graphical representation in FIG. 28 is not time limited, it should be appreciated that any suitable time restrictions may be used for aggregating personal data when generating a report in accordance with embodiments of the invention.

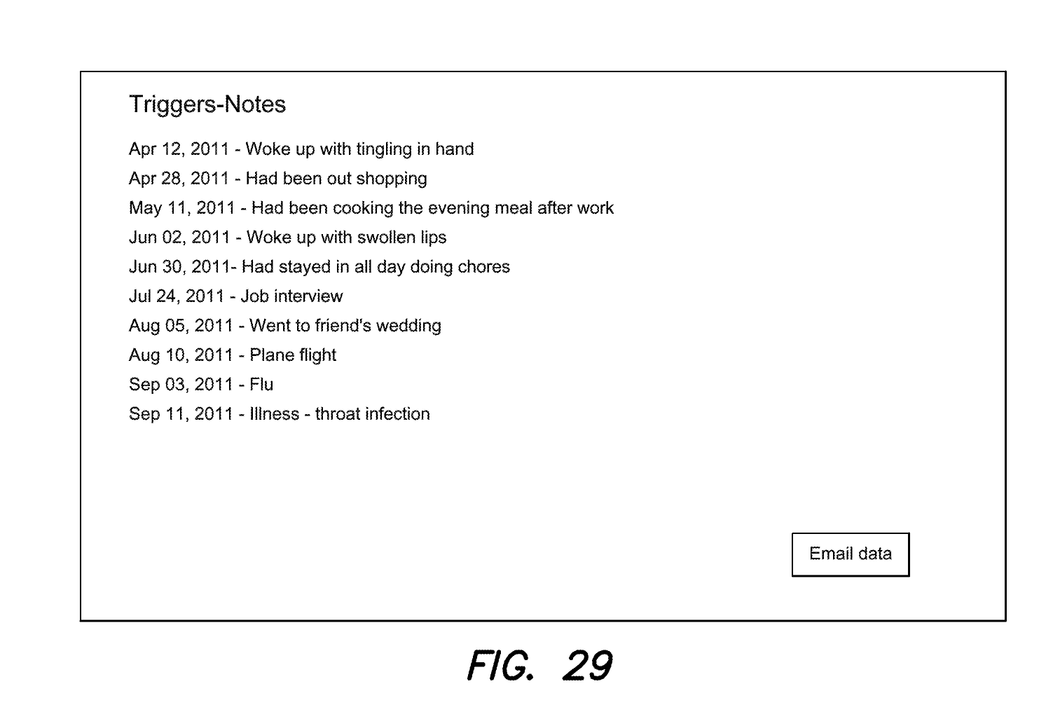

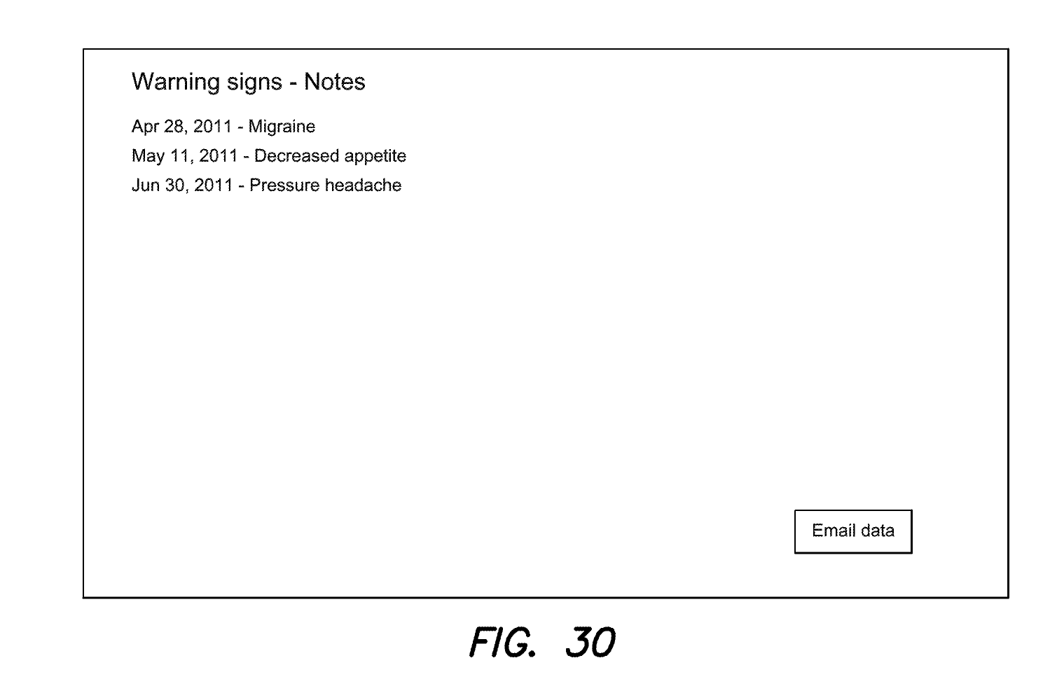

Reports generated using personal information stored for multiple attack episodes may include in addition to graphical representations, one or more summaries of notes associated with the selected report metric. For example, FIGS. 29 and 30 each illustrates a portion of a report that includes notes recorded as personal information by a user during a selected time period. By reviewing the notes for a particular report metric, a patient and/or the patient's physician may be better able to assess recommendations for reducing the frequency and/or severity of attack episodes and to determine more effective treatment options.

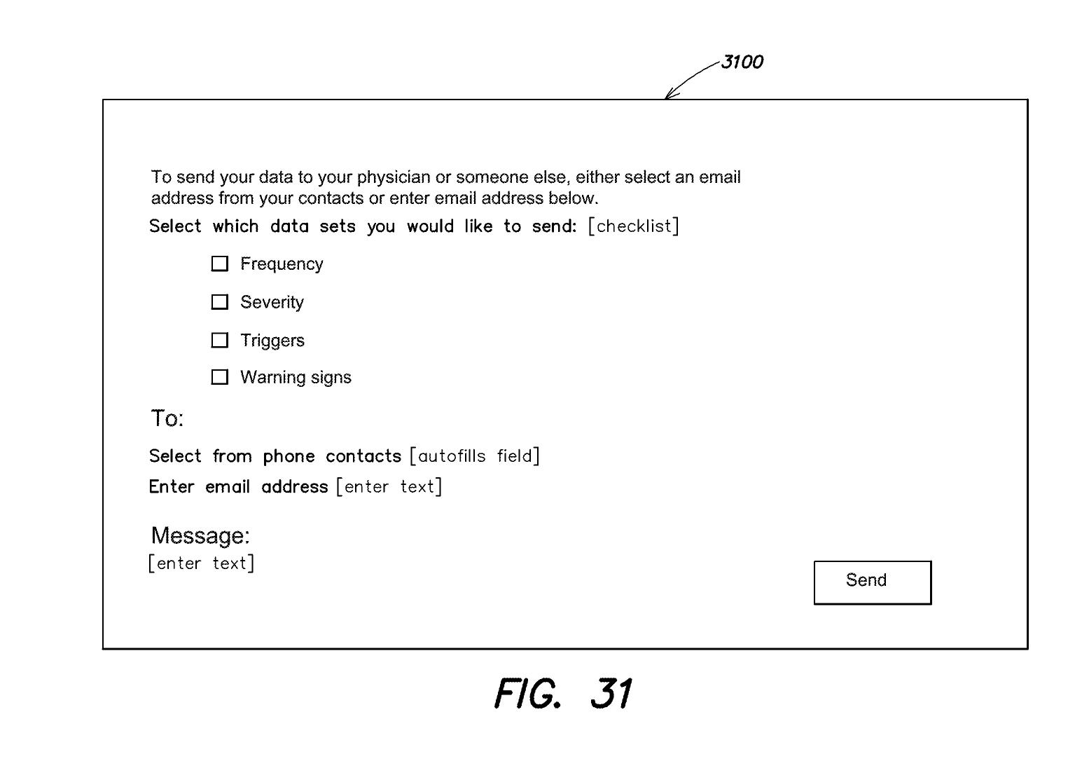

Some or all of the information in a report generated in response to a request from a user may be transmitted to one or more other users via a communication medium. For example, in some embodiments, a user may interact with a report communication page 3100, an example of which is illustrated in FIG. 31, to send all or a portion of a report to another user via email. Additionally, in some embodiments, reports corresponding to reports generated for individual report metrics may be sent to another user by interacting directly with a report page corresponding the report metric. Report communication page 3100 may additionally include at least one interactive field configured to enable the user to input comments to send with the report(s) to another user.

Some attack episodes caused by a disease may require a patient to seek immediate emergency medical services. For example, some patients with HAE may experience swelling in the neck and throat area during an attack. Swelling in these areas are extremely serious as the swelling may restrict the airway thereby limiting the patient's ability to breathe normally. Patients diagnosed with diseases such as HAE often carry a wallet-size card with them explaining the disease and what to do in case of an emergency. However, in an emergency situation, others may not consider to look in the person's wallet for emergency information regarding how to help the person suffering an attack. To this end, some embodiments are directed to using a portable electronic device to communicate emergency information about an attack.

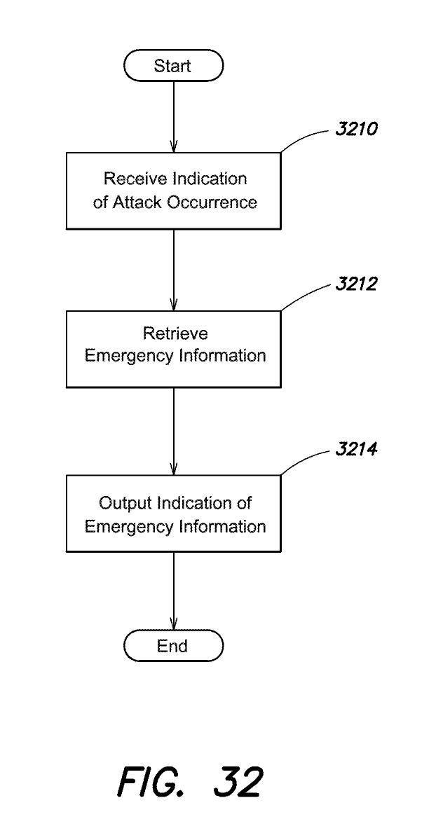

FIG. 32 illustrates an exemplary process for communicating emergency information in accordance with some embodiments of the invention. In act 3210, an indication than an attack has occurred or that an attack is likely may be received. For example, a user may identify one or more warning signs that signal that an attack is likely. In response to identifying the warning signs, the user may interact with the portable electronic device (e.g., by pressing an emergency button) to initiate the emergency information communication procedure.

In response to receiving an indication related to an attack occurrence, the process proceeds to act 3212 where emergency information is retrieved from at least one storage medium associated with the portable electronic device. For example, the portable electronic devices may store emergency information using local storage to avoid the possible consequences of not having a network connection. In response to retrieving the emergency information, the process proceeds to act 3214 where an indication of the emergency information is output.

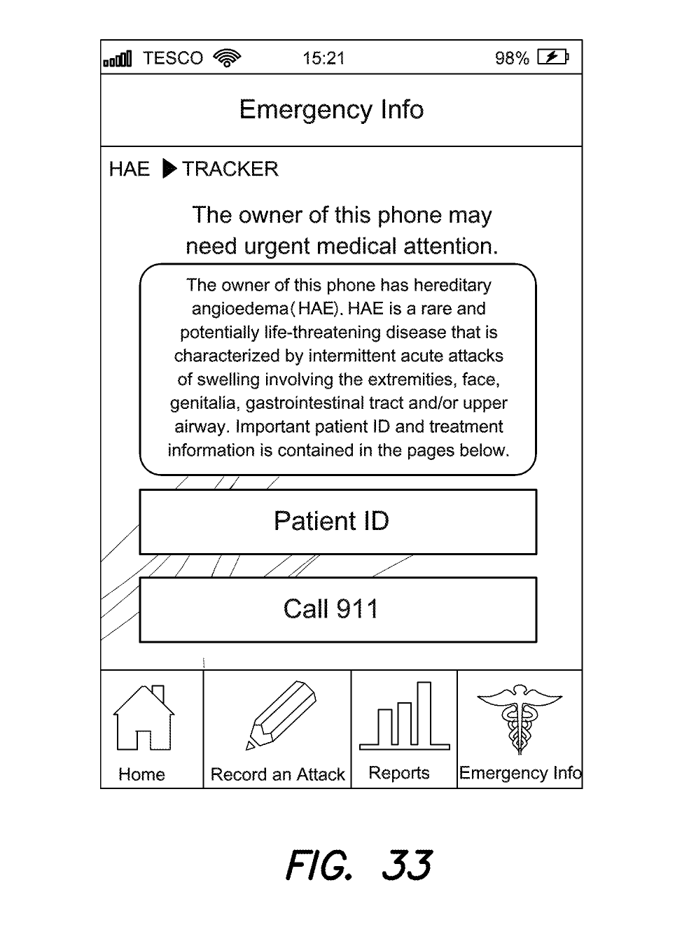

The indication of the emergency information may be output in any suitable way. For example, the emergency information may be displayed on a display of the portable electronic device as shown in FIG. 33. As illustrated in FIG. 33, the emergency information may include a message explaining at least one aspect of the disease. The message may also explain what to do in the case of an emergency including providing instructions on who to contact. The message may be provided by a designer of an application executing on the portable electronic device or the message may be input by a user of the device. In some embodiments, the indication of emergency information may be provided by synthesizing and outputting speech corresponding to the emergency information from the portable electronic device. The speech may be output instead of, or in addition to, displaying the emergency information on a display of the portable electronic device.

In some embodiments, when an indication of an attack episode is received, an audio alert may be output from the portable electronic device to alert others that emergency medical services may be needed and to alert others to check the phone for instructions about what to do in the case of an emergency.

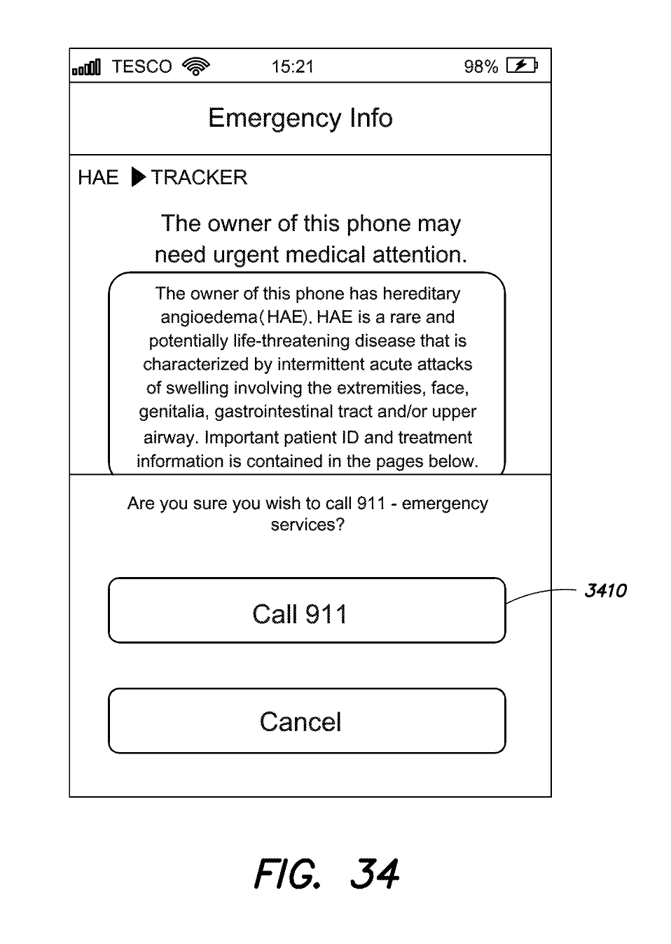

In some embodiments, the emergency information may be provided as a portion of a user interface displayed on the portable electronic device as shown in FIG. 34 and the user interface may include an emergency selector 3410 configured to enable a user to call emergency services (e.g., call 911). In response to receiving a selection of the emergency selector 3410, the user may be prompted to provide a confirmation to call emergency services, and in response to receiving the confirmation, emergency services may be called.

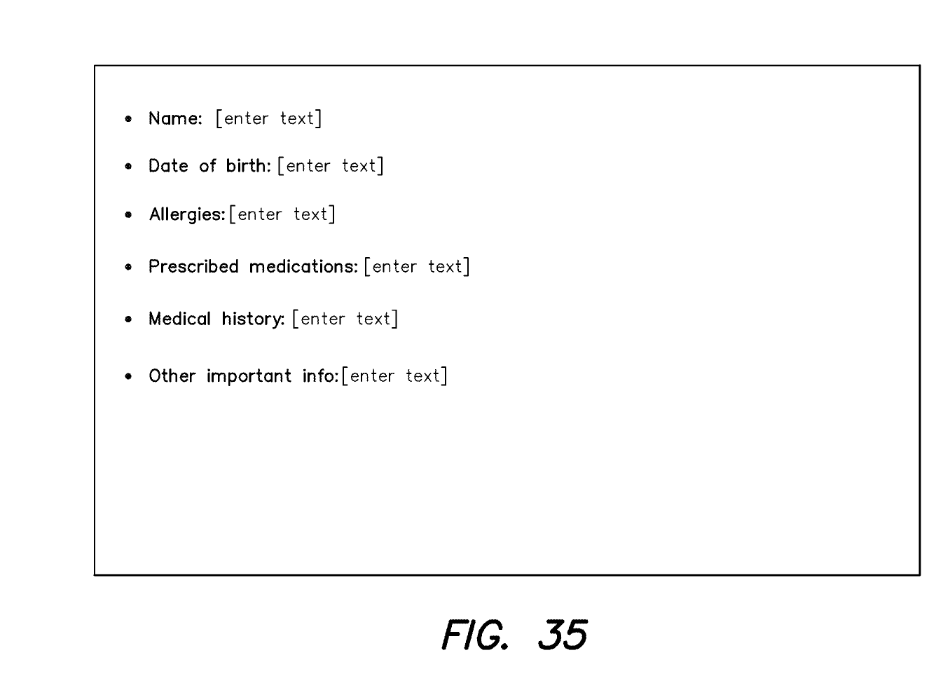

Some embodiments are directed to a user interface configured to enable a user to enter emergency information that may be communicated in response to the detection of an attack episode. The user interface may include a plurality of interactive fields with which a user may interact to record emergency information in the case of an attack. FIG. 35 illustrates an exemplary emergency information page including a plurality of fields for entering emergency information. For example, the emergency information that may be input includes patient identification information, such as name and date of birth, allergy information, medication information, medical history information, and any other important information that others should be aware of in the case of an emergency. The emergency information stored by the portable electronic device may be recalled and output to others in response to a user initiating an emergency process as described above.

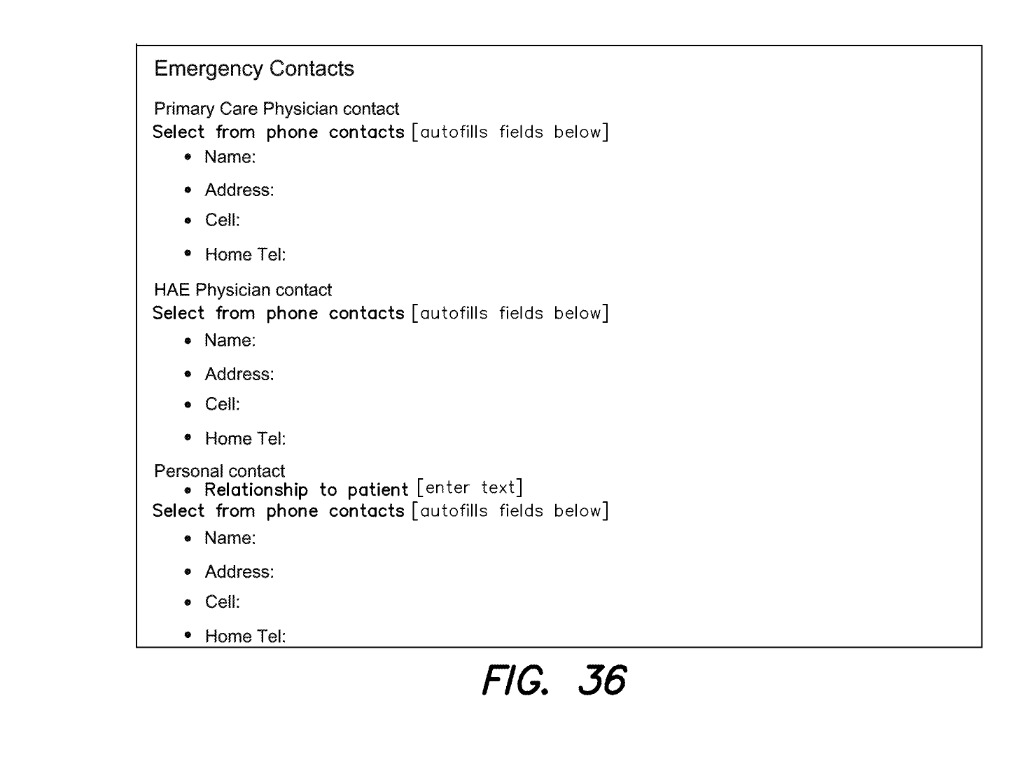

In some embodiments, the emergency information may include emergency contact information as shown in FIG. 36. The emergency contact information may include contact information for a healthcare professional including one or more of the user's physicians and contact information for a personal contact, such as the user's spouse, parents, or children. The emergency contact information may be presented to others in response to the user activating an emergency process as described above.

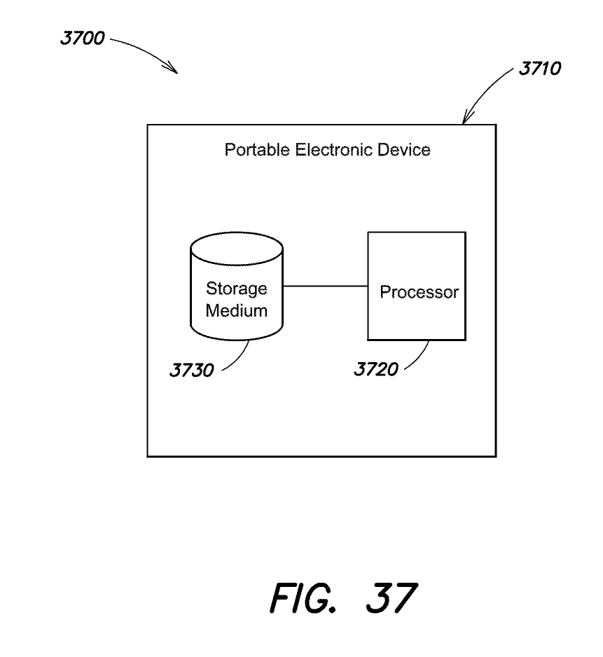

FIG. 37 illustrates an example of a suitable computing system environment 3700 on which the invention may be implemented. The computing system environment 3700 is only one example of a suitable computing environment and is not intended to suggest any limitation as to the scope of use or functionality of the invention. Neither should the computing environment 3700 be interpreted as having any dependency or requirement relating to any one or combination of components illustrated in the exemplary operating environment 3700.

The invention is operational with numerous other general purpose or special purpose computing system environments or configurations. Examples of well known computing systems, environments, and/or configurations that may be suitable for use with the invention include, but are not limited to, personal computers, hand-held or laptop devices, multiprocessor systems, microprocessor-based systems, programmable consumer electronics, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 37, an exemplary system for implementing the invention includes a general purpose computing device in the form of a portable electronic device 3710, such as a smartphone or a tablet computer. The portable electronic device 3710 may include one or more processors 3720 and one or more non-transitory computer-readable storage media 3730.

Computer-readable storage media can be any available media that can be accessed by portable electronic device 3710 and includes both volatile and nonvolatile media, removable and non-removable media. Computer-readable storage media includes both volatile and nonvolatile, removable and non-removable media implemented in any method or technology for storage of information such as computer readable instructions, data structures, program modules or other data. Computer-readable storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by portable electronic device 3710. Combinations of the any of the above should also be included within the scope of computer readable media.

Having thus described several aspects of at least one embodiment of this invention, it is to be appreciated that various alterations, modifications, and improvements will readily occur to those skilled in the art.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, a portable electronic device may have one or more input and output devices. These devices can be used, among other things, to present a user interface. Examples of output devices that can be used to provide a user interface include a display screen for visual presentation of output and speakers or other sound generating devices for audible presentation of output. Examples of input devices that can be used for a user interface include keyboards, and pointing devices, such as mice, touch pads, and digitizing tablets. As another example, a portable electronic device may receive input information through speech recognition or in other audible format.

Such portable electronic devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of collecting information related to an attack caused by a disease, wherein the information is collected using a portable electronic device, the method comprising:
receiving from a user, via at least one user interface displayed by the portable electronic device, personal information characterizing at least one aspect of the attack;
associating the received personal information with temporal information associated with the attack; and
storing the personal information and the temporal information in at least one storage medium associated with the portable electronic device.

2. The method of claim 1, wherein the personal information is selected from the group consisting of: a severity rating of the attack, information related to treatment received for the attack, information related to at least one suspected trigger for the attack, information related to at least one physical warning sign observed by the user prior to the attack, an identification of at least one body region of the user affected by the attack, a degree of swelling associated with the identified at least one body region, an identification of at least one physical symptom associated with the attack, and information related to an impact of the attack on a psychological condition of the user.

3. The method of claim 1, wherein receiving the personal information comprises:
receiving, with a camera associated with the portable electronic device, at least one photograph depicting at least a portion of the user prior to and/or during the attack.

4. The method of claim 1, wherein the temporal information is selected from the group consisting of: date and/or time information regarding when the attack peaked in severity, a duration of the attack, and date and/or time information regarding an onset of the attack.

5. The method of claim 1, further comprising:
prompting the user to provide the personal information via the user interface.

6. The method of claim 1, wherein the disease is hereditary angioedema (HAE).

7. A computer-readable medium encoded with a plurality of instructions that, when executed by a computer, perform a method of generating a report including personal information related to one or more attacks caused by a disease, the method comprising:
receiving via a user interface displayed on a portable electronic device, a request from a user to generate the report;
retrieving from at least one storage device associated with the portable electronic device, personal information related to the one or more attacks;
generating the report based, at least in part, on the retrieved personal information; and
displaying the generated report on a display of the portable electronic device.

8. The computer-readable medium of claim 7, wherein the request to generate the report includes an indication to generate the report for a single attack, wherein generating the report comprises consolidating at least some of the retrieved personal information into an attack profile, wherein the attack profile includes information related to at least one physical symptom associated with the single attack, and wherein displaying the generated report comprises displaying a representation of the attack profile.

9. The computer-readable medium of claim 7, wherein the method further comprises:
displaying on the user interface a communication selector that, when selected by a user, enables the user to send information associated with the report to another user via at least one communication network.

10. The computer-readable medium of claim 7, wherein the request to generate the report includes an indication to generate the report for a plurality of attacks during a specified time period, wherein the method further comprises:
aggregating the retrieved personal information for the plurality of attacks during the specified time period to produce aggregated personal information data; and
wherein displaying the generated report comprises displaying at least some of the aggregated personal information data.

11. The computer-readable medium of claim 10, wherein the method further comprises:
prompting the user to select a report metric from a plurality of report metrics; and
wherein aggregating the retrieved personal information comprise aggregating the retrieved personal information based, at least in part, on the selected report metric.

12. The computer-readable medium of claim 11, wherein the method further comprises:
displaying a plurality of time period selectors configured to enable the user to select different specified time periods for aggregating the retrieved personal information.

13. A method of using a portable electronic device to communicate emergency information about an attack caused by a disease, the method comprising:
receiving an indication that an attack has occurred or is likely to occur;
retrieving, with at least one processor, the emergency information from at least one storage medium associated with the portable electronic device; and
outputting an indication of the emergency information in response to retrieving the emergency information from the at least one storage medium.

14. The method of claim 13, further comprising:
displaying a user interface on a display of the portable electronic device, wherein the user interface is configured to prompt a user to input the emergency information;
receiving the emergency information in response to a user interacting with the user interface; and
storing the received emergency information in the at least one storage medium.

15. The method of claim 13, wherein the emergency information is selected from the group consisting of: patient identification information, medication information, medical history information, at least one photograph of the user, and emergency contact information.

16. The method of claim 13, wherein determining that an attack has occurred or is likely to occur comprises receiving an input from a user indicating that the attack has occurred or is likely to occur.

17. The method of claim 13, wherein outputting an indication of the emergency information comprises displaying the emergency information on a display of the portable electronic device and/or outputting from the portable electronic device, speech corresponding to the emergency information.

18. The method of claim 13, further comprising:
outputting from the portable electronic device, an audio alert in response to determining that an attack has occurred or is likely to occur.

19. The method of claim 13, further comprising:
displaying a user interface on a display of the portable electronic device, wherein the user interface includes an emergency contact selector configured to enable a user to call emergency services;
receiving a selection of the emergency contact selector;
prompting the user for confirmation to call emergency services; and
initiating a call to emergency services in response to receiving confirmation from the user.

20. The method of claim 13, wherein the portable electronic device is selected from the group consisting of: a cellular phone, a smartphone, a personal digital assistant, a tablet computer, and a laptop computer.
